(19) United States
(12) Patent Application Publication
(10) Pub. No.: US 2026/0181409 A1
(43) Pub. Date: Jun. 25, 2026

(54) BEAM MANAGEMENT FOR WIRELESS ENERGY TRANSFER

(71) Applicant: QUALCOMM Incorporated, San Diego, CA (US)

(72) Inventors: Xiaojie WANG, Hillsborough, NJ (US); Luanxia YANG, Beijing (CN); Xiaoxia ZHANG, San Diego, CA (US); Navid ABEDINI, Basking Ridge, NJ (US)

(21) Appl. No.: 19/124,746

(22) PCT Filed: Dec. 21, 2022
(86) PCT No.: PCT/CN2022/140612

§ 371 Date: Apr. 25, 2025

(51) Int. Cl. H04W 16/28; H04W 24/10; H04W 72/044; H04W 72/23

(52) U.S. Cl. CPC H04W 16/28; H04W 24/10; H04W 72/046; H04W 72/23

(57) ABSTRACT

Aspects relate to beam management schemes for wireless energy transfer and information (e.g., data) transfer. A user equipment (UE) may transmit a UE capability thereof to a network entity that indicates a receiver architecture of the UE. The network entity may then select a beam management scheme based on the receiver architecture of the UE and communicate with the UE using the selected beam management scheme. The selected beam management scheme may include one or more beams to provide both an energy transmission and an information transmission to the UE.

### TECHNICAL FIELD

The technology discussed below relates generally to wireless communication networks, and more particularly, to mechanisms for beam management for energy and information transmissions.

### INTRODUCTION

The 5G New Radio (NR) mobile telecommunication systems can provide higher data rates, lower latency, and improved system performance than previous generation systems. In addition, the 3rd Generation Partnership Project (3G PP) has specified several cellular technologies for applications related to the Internet of Things (IoT) in licensed spectrum, including Long Term Evolution (LTE) for machine-type communications (LTE-M), narrowband IoT (NB-IoT) supporting massive machine type communication (mMTC), reduced capability (RedCap) for MTC, extended-coverage GSM for IoT (EC-GSM-IoT), and ultra-reliable low-latency communications (URLLC). Applications include, for example, sensors, surveillance cameras, wearable devices, smart meters and smart meter sensors. To meet the power requirements in 5G NR and IoT wireless communications, wireless communication devices (e.g., user equipment (UEs)) may be configured to perform radio frequency (RF) energy harvesting to accumulate energy over time. The accumulated energy can charge a power source (e.g., a battery) of the wireless communication device to perform various tasks, such as data reception, data decoding, data encoding, and data transmission.

5G may further be extended to support passive IoT devices, such as radio frequency identification (RFID) devices. RFID devices include small transponders, or tags, capable of emitting an information-bearing signal upon receiving a signal. For example, passive RFID devices may harvest energy over the air to power the transmission/reception circuitry, thereby enabling a backscatter modulated information signal to be transmitted. Passive RFID sensors may be used, for example, in asset management, logistics, warehousing, and manufacturing.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a network entity configured for wireless communication is disclosed. The network entity includes a memory and a processor coupled to the memory. The processor is configured to receive a user equipment (UE) capability of a UE. The UE capability indicating a receiver architecture of the UE to support energy harvesting and information decoding. The processor is further configured to communicate with the UE using a beam management scheme selected based on the UE capability. The beam management scheme including one or more beams for providing an energy transmission and an information transmission to the UE.

Another example provides a method operable at a network entity. The method includes receiving a user equipment (UE) capability of a UE. The UE capability indicating a receiver architecture of the UE to support energy harvesting and information decoding. The method further includes communicating with the UE using a beam management scheme selected based on the UE capability. The beam management scheme including one or more beams for providing an energy transmission and an information transmission to the UE.

Another example provides a user equipment (UE) configured for wireless communication. The UE includes a transceiver, a memory, and a processor coupled to the transceiver and the memory. The processor is configured to transmit a UE capability to a network entity via the transceiver. The UE capability indicating a receiver architecture of the UE to support energy harvesting and information decoding. The processor is further configured to communicate with the network entity using a beam management scheme based on the UE capability. The beam management scheme including one or more beams for providing an energy transmission and an information transmission to the UE.

Another example provides a method operable at a user equipment (UE). The method includes transmitting a UE capability to a network entity. The UE capability indicating a receiver architecture of the UE to support energy harvesting and information decoding. The method further includes communicating with the network entity using a beam management scheme based on the UE capability. The beam management scheme including one or more beams for providing an energy transmission and an information transmission to the UE.

These and other aspects will become more fully understood upon a review of the detailed description, which follows. Other aspects, features, and examples will become apparent to those of ordinary skill in the art, upon reviewing the following description of specific, exemplary examples of in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. In similar fashion, while exemplary examples may be discussed below as device, system, or method examples such exemplary examples can be implemented in various devices, systems, and methods.

### BRIEF DESCRIPTION OF THE DRAWINGS

FIG. 1 is a schematic illustration of a wireless communication system according to some aspects.

FIG. 2 is a diagram illustrating an example of a radio access network (RAN) according to some aspects.

FIG. 3 is a schematic illustration of an organization of wireless resources in an air interface utilizing orthogonal frequency divisional multiplexing (OFDM) according to some aspects.

FIG. 4 is a diagram providing a high-level illustration of one example of a configuration of a disaggregated base station according to some aspects.

FIG. 5 illustrates an example of a wireless communication network configured to support internet of things (IoT) according to some aspects.

FIG. 6 is a diagram illustrating an example of energy harvesting according to some aspects.

FIGS. 7A, 7B, and 7C are diagrams illustrating examples of energy harvesting receiver architectures according to some aspects.

FIG. 8 illustrates an example of a wireless communication system supporting beamforming between a network entity and a UE/IoT device according to some aspects.

FIG. 9 is a diagram illustrating an example of a transmitter architecture for beamforming according to some aspects.

FIG. 10 is a signaling diagram illustrating exemplary signaling for beam management of wireless energy and information transmissions according to some aspects.

FIG. 11 is a diagram illustrating an example of a fully decoupled beam management scheme according to some aspects.

FIG. 12 is a flowchart illustrating an exemplary method for fully decoupled beam management according to some aspects.

FIG. 13 is a diagram illustrating an example of a fully coupled beam management scheme according to some aspects.

FIG. 14 is a flowchart illustrating an exemplary method for fully coupled beam management according to some aspects.

FIG. 15 is a diagram illustrating an example of a partially coupled beam management scheme according to some aspects.

FIG. 16 is a flowchart illustrating an exemplary method for partially coupled beam management according to some aspects.

FIG. 17 is a flowchart illustrating an exemplary method for managing a beam failure on a communication link according to some aspects.

FIG. 18 is a flowchart illustrating an exemplary method for managing a beam failure on an energy harvesting link using a fully decoupled beam management scheme according to some aspects.

FIG. 19 is a flowchart illustrating another exemplary method for managing a beam failure on an energy harvesting link using a fully decoupled beam management scheme according to some aspects.

FIG. 20 is a flowchart illustrating another exemplary method for managing a beam failure on an energy harvesting link using a fully decoupled beam management scheme according to some aspects.

FIG. 21 is a flowchart illustrating an exemplary method for managing a beam failure using a fully coupled beam management scheme or a partially coupled beam management scheme according to some aspects.

FIG. 22 is a flowchart illustrating an exemplary method for managing a beam failure using a fully coupled beam management scheme or a partially coupled beam management scheme according to some aspects.

FIG. 23 is a flowchart illustrating an exemplary method for managing a beam failure using a fully coupled beam management scheme or a partially coupled beam management scheme according to some aspects.

FIG. 24 is a flowchart illustrating an exemplary method for managing a beam failure using a fully coupled beam management scheme or a partially coupled beam management scheme according to some aspects.

FIG. 25 is a block diagram illustrating an example of a hardware implementation for a user equipment (UE) employing a processing system according to some aspects.

FIG. 26 is a flow chart of an exemplary method 2600 for beam management for wireless energy transfer according to some aspects.

FIG. 27 is a block diagram illustrating an example of a hardware implementation for a network entity employing a processing system according to some aspects.

FIG. 28 is a flow chart of an exemplary method 2800 for beam management for wireless energy transfer according to some aspects.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the disclosure relate to beam management schemes for providing one or more beams for both wireless energy transfer and information (e.g., data) transfer to UEs (e.g., IoT devices). The different beam management schemes take into account different receiver architectures of UE/IoT devices to support both energy harvesting and information decoding. For example, a UE may transmit a UE capability thereof to a network entity (e.g., an aggregated or disaggregated base station). The UE capability may indicate a receiver architecture of the UE. The network entity may then select a beam management scheme based on the receiver architecture of the UE and communicate with the UE using the selected beam management scheme to provide both an energy transmission and an information transmission to the UE.

Examples of beam management schemes include fully decoupled, fully coupled, and partially coupled. In a fully decoupled beam management scheme, separate time-division multiplexed beams are used for energy and information transmissions. The fully decoupled beam management scheme may be applicable to a time-splitting receiver architecture in the UE/IoT device. In a fully coupled beam management scheme, the same beam is used for both energy and information transmissions (e.g., the energy and information transmissions are superposed). The fully coupled beam management scheme may be applicable to a power-splitting receiver architecture in the UE/IoT device.

In a partially coupled beam management scheme, separate spatial division multiplexed beams are used for energy and information transmissions during the same time period. The partially coupled beam management scheme may be applicable to a power-splitting receiver architecture in the UE/IoT device. In some examples, the partially coupled beam management scheme may be utilized for UE groups. For example, a wide beam may be used to supply power (e.g., provide an energy transmission) to a first UE group, while narrower beams may be used to provide respective information transmissions to each UE within the first UE group or a second UE group, where there may be partial or no overlap between members of the different UE groups. The narrow beams may be selected to avoid mutual interference between the information transmissions.

Based on the selected beam management scheme, the UE may further provide a beam failure report (BFR) related to the beam(s) used for both the energy transmission and the information transmission. For example, in the fully decoupled beam management scheme, the UE may provide a BFR for the information beam based on a measured reference signal received power (RSRP) of the information beam. Similarly, the UE may provide a BFR for the energy beam based on an energy conversion efficiency of the energy beam. In the fully coupled and partially coupled beam management schemes, the UE may provide a BFR for both the information beam and the energy beam based on at least one of the measured RSRP or the energy conversion efficiency.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station or UE), end-user devices, etc. of varying sizes, shapes and constitution.

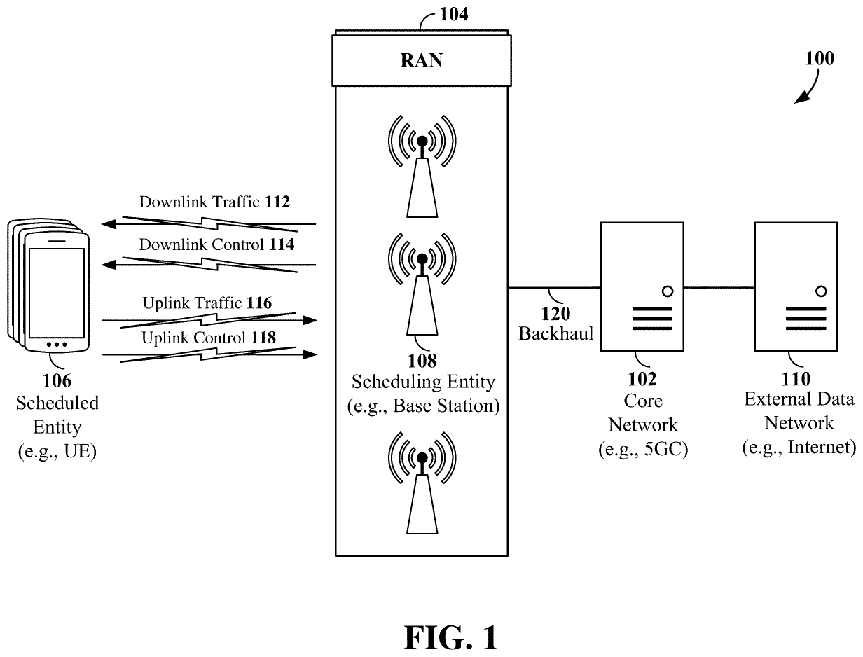

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station. In addition, one or more of the base stations may have a disaggregated configuration.

The RAN 104 is further illustrated supporting wireless communication for multiple mobile apparatuses. A mobile apparatus may be referred to as user equipment (UE) in 3G PP standards, but may also be referred to by those skilled in the art as a mobile station (M S), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmissions. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a network entity, such as a node or device, responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control information 114 and/or 118 and/or traffic 112 and/or 116 information may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5G C). In other examples, the core network 102 may be configured according to a 4G evolved packet core (EPC), or any other suitable standard or configuration.

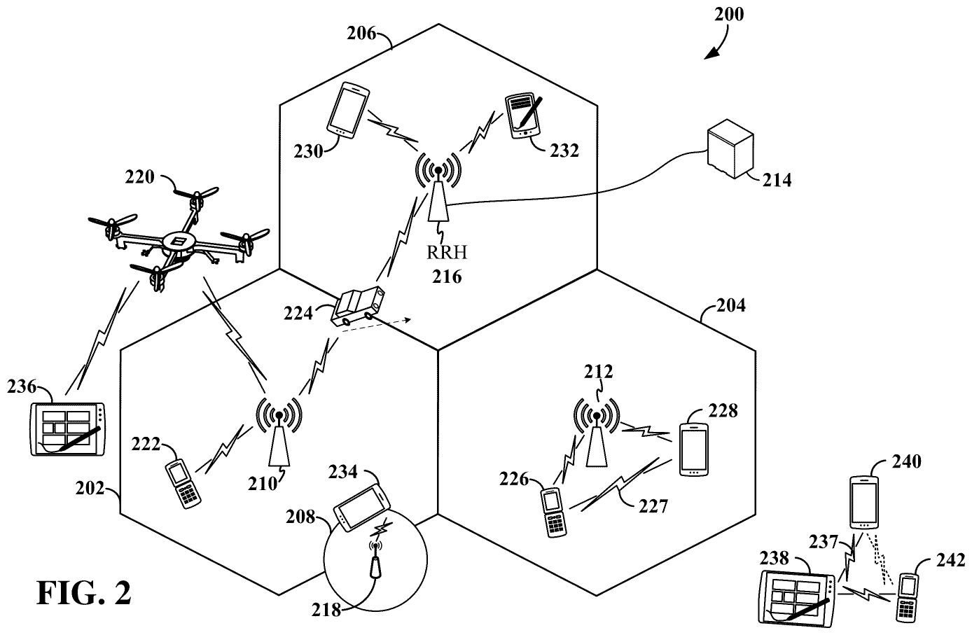

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same network entity (e.g., base station). A radio link within a sector can be identified by a single logical identification belonging to that sector. In a cell that is divided into sectors, the multiple sectors within a cell can be formed by groups of antennas with each antenna responsible for communication with UEs in a portion of the cell.

Various network entity (e.g., base station) arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RR H 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In some examples, a D2D relay framework may be included within a cellular network to facilitate relaying of communication to/from the base station 212 via D2D links (e.g., sidelinks 227 or 237). For example, one or more UEs (e.g., UE 228) within the coverage area of the base station 212 may operate as relaying UEs to extend the coverage of the base station 212, improve the transmission reliability to one or more UEs (e.g., UE 226), and/or to allow the base station to recover from a failed UE link due to, for example, blockage or fading.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEA F) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or F R 2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (C P). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SD D, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full duplex (SBFD), also known as flexible duplex.

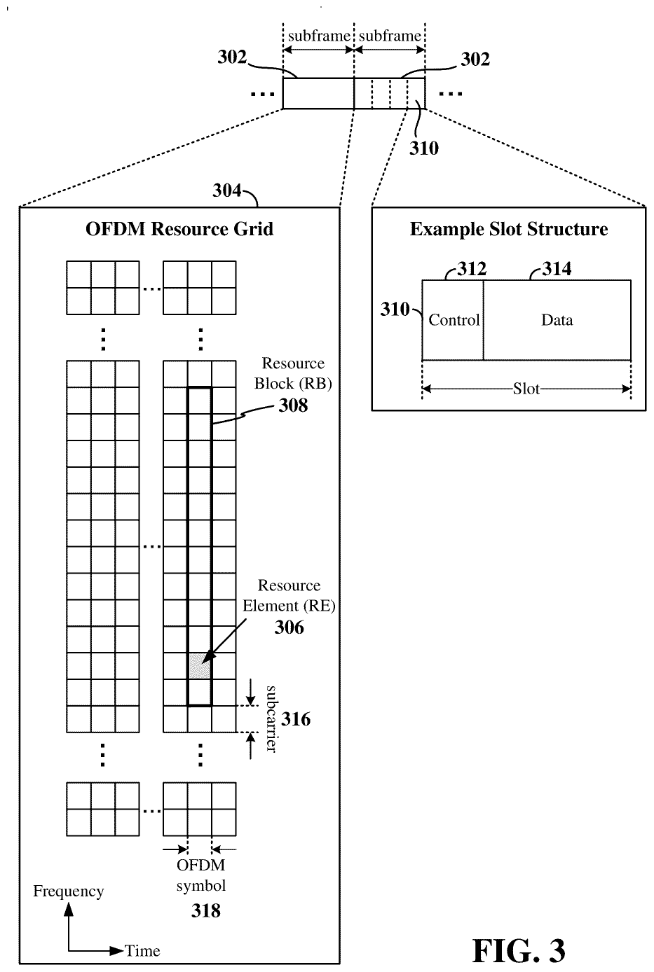

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissions such as an acknowledgement (ACK) or negative acknowledgement (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NA CK may be transmitted. In response to a NA CK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSB s may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CO RESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data traffic. Such data traffic may be carried on one or more traffic channels, such as, fora DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data traffic transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 3 are not necessarily all of the channels or carriers that may be utilized between devices, and those of ordinary skill in the art will recognize that other channels or carriers may be utilized in addition to those illustrated, such as other traffic, control, and feedback channels.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing basestation functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DU s may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

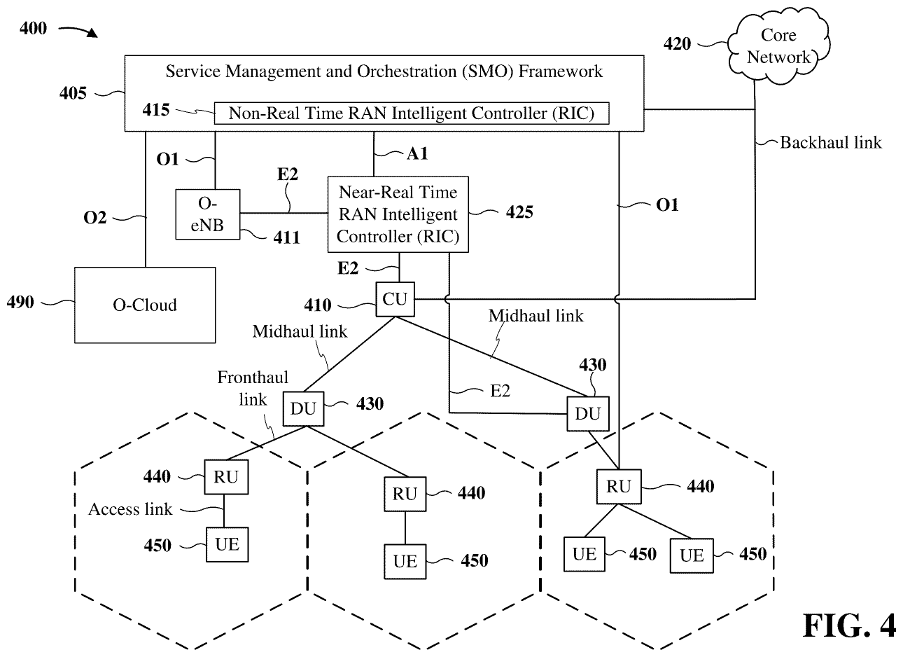

FIG. 4 shows a diagram illustrating an example disaggregated base station 400 architecture. The disaggregated base station 400 architecture may include one or more central units (CUs) 410 that can communicate directly with a core network 420 via a backhaul link, or indirectly with the core network 420 through one or more disaggregated basestation units (such as a Near-Real Time (Near-RT) RAN Intelligent Controller (RIC) 425 via an E2 link, or a Non-Real Time (Non-RT) RIC 415 associated with a Service Management and Orchestration (SMO) Framework 405, or both). A CU 410 may communicate with one or more distributed units (DU s) 430 via respective midhaul links, such as an F1 interface. The DUs 430 may communicate with one or more radio units (RU s) 440 via respective fronthaul links. The RU s 440 may communicate with respective UEs 450 via one or more radio frequency (RF) access links. In some implementations, the UE 450 may be simultaneously served by multiple RU s 440.

E ach of the units, i.e., the CUs 410, the DUs 430, the RUs 440, as well as the Near-RT RICs 425, the Non-RT RICs 415 and the SMO Framework 405, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 410 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 410. The CU 410 may be configured to handle user plane functionality (i.e., Central Unit-User Plane (CU-UP)), control plane functionality (i.e., Central Unit-Control Plane (CU-CP)), or a combination thereof. In some implementations, the CU 410 can be logically split into one or more CU-UP units and one or more CU-CP units. The CU-UP unit can communicate bidirectionally with the CU-CP unit via an interface, such as the E1 interface when implemented in an O-RAN configuration. The CU 410 can be implemented to communicate with the DU 430, as necessary, for network control and signaling.

The DU 430 may correspond to a logical unit that includes one or more base station functions to control the operation of one or more RUs 440. In some aspects, the DU 430 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 430 may further host one or more low PHY layers. Each layer (or module) can be implemented with an interface configured to communicate signals with other layers (and modules) hosted by the DU 430, or with the control functions hosted by the CU 410.

Lower-layer functionality can be implemented by one or more RUs 440. In some deployments, an RU 440, controlled by a DU 430, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 440 can be implemented to handle over the air (OTA) communication with one or more UEs 450. In some implementations, real-time and non-real-time aspects of control and user plane communication with the RU(s) 440 can be controlled by the corresponding DU 430. In some scenarios, this configuration can enable the DU(s) 430 and the CU 410 to be implemented in a cloud-based RAN architecture, such as a vRAN architecture.

The SMO Framework 405 may be configured to support RAN deployment and provisioning of non-virtualized and virtualized network elements. For non-virtualized network elements, the SMO Framework 405 may be configured to support the deployment of dedicated physical resources for RAN coverage requirements which may be managed via an operations and maintenance interface (such as an O1 interface). For virtualized network elements, the SMO Framework 405 may be configured to interact with a cloud computing platform (such as an open cloud (O-Cloud) 490) to perform network element life cycle management (such as to instantiate virtualized network elements) via a cloud computing platform interface (such as an O2 interface). Such virtualized network elements can include, but are not limited to, CUs 410, DUs 430, RUs 440 and Near-RT RICs 425. In some implementations, the SMO Framework 405 can communicate with a hardware aspect of a 4G RAN, such as an open eNB (O-eNB) 411, via an O1 interface. Additionally, in some implementations, the SMO Framework 405 can communicate directly with one or more RUs 440 via an O1 interface. The SMO Framework 405 also may include a Non-RT RIC 415 configured to support functionality of the SMO Framework 405.

The Non-RT RIC 415 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 425. The Non-RT RIC 415 may be coupled to or communicate with (such as via an A1 interface) the Near-RT RIC 425. The Near-RT RIC 425 may be configured to include a logical function that enables near-real-time control and optimization of RAN elements and resources via data collection and actions over an interface (such as via an E2 interface) connecting one or more CUs 410, one or more DUs 430, or both, as well as an O-eNB, with the Near-RT RIC 425.

In some implementations, to generate AI/ML models to be deployed in the Near-RT RIC 425, the Non-RT RIC 415 may receive parameters or external enrichment information from external servers. Such information may be utilized by the Near-RT RIC 425 and may be received at the SMO Framework 405 or the Non-RT RIC 415 from non-network data sources or from network functions. In some examples, the Non-RT RIC 415 or the Near-RT RIC 425 may be configured to tune RAN behavior or performance. For example, the Non-RT RIC 415 may monitor long-term trends and patterns for performance and employ AI/ML models to perform corrective actions through the SMO Framework 405 (such as reconfiguration via O1) or via creation of RAN management policies (such as A1 policies).

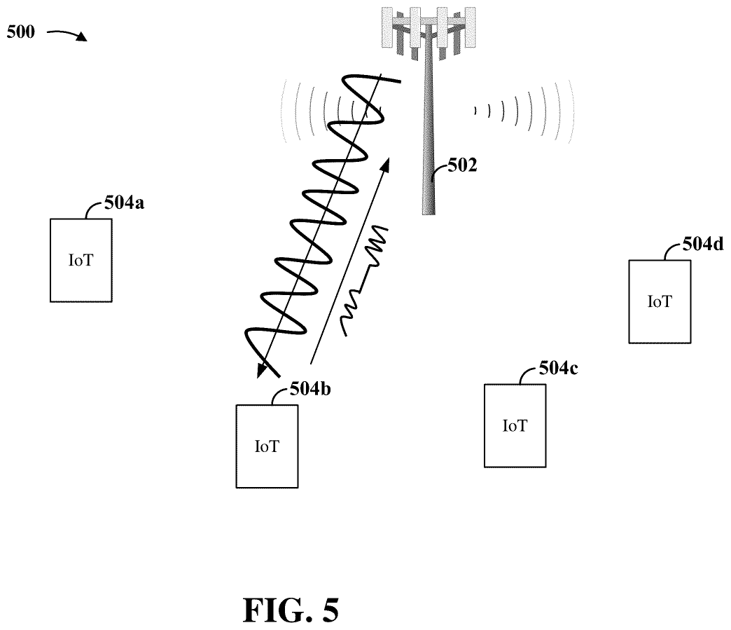

FIG. 5 illustrates an example of a wireless communication network 500 configured to support internet of things (IoT) according to some aspects. The IoT network 500 may include a network entity (e.g., gNB) 502 and a plurality of IoT devices 504a, 504b, 504c, and 504b. The IoT devices 504a-504d may include, for example, passive IoT devices, such as RFID-type sensors/actuators (SAs). The network entity 502 and IoT devices 504a-504d may communicate, for example, via cellular (Uu) links. For example, the network entity 502 may provide an energy transmission 506 that may be received by one or more passive IoT devices 504a-504d. The energy transmission 506 may provide power to the transmit/receive circuitry within the passive IoT devices 504a-504d to enable an information-bearing signal 508 to be reflected from a passive IoT device (e.g., IoT device 504b) towards the network entity 502. In some examples, the information-bearing signal 508 may be a backscatter modulated information signal. The network entity 502 may receive the reflected signal and decode the information included in the reflected signal. In this manner, the network entity 502 may read information from the IoT devices 504a-504d and write information to the IoT devices 504a-504d.

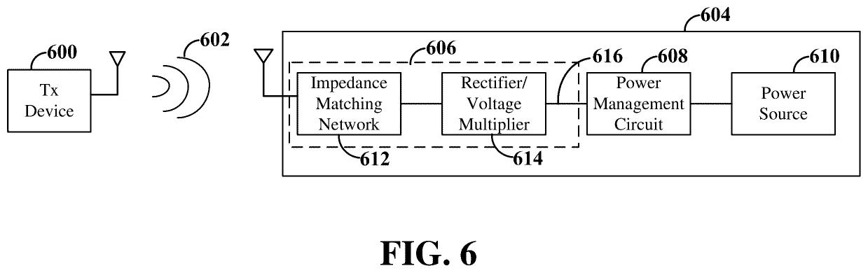

FIG. 6 is a diagram illustrating an example of energy harvesting according to some aspects. In the example shown in FIG. 6, a transmitting (Tx) device 600, such as a network entity, transmits an RF signal 602 to a receiving (Rx) device 604, such as a wireless communication device (e.g., a UE or other IoT device).

The Rx device 604 includes energy harvesting circuit 606, a power management circuit 608, and a power source 610 (e.g., a battery). The energy harvesting circuit 606 includes an impedance matching network 612 and a rectifier/voltage multiplier 614 configured to receive the RF signal 602 and convert the RF signal 602 into a direct current (DC) signal (e.g., output power) 616. The power management circuit 608 is configured to charge the power source 610 (e.g., store the output power 616 obtained from the energy harvesting circuit 606) or to use the output power 616 immediately to perform one or more data transmission/reception tasks.

Unlike energy harvesting from other sources (e.g., wind, solar, vibrations, etc.), RF energy harvesting (EH) can provide controllable and constant energy transfer over distance. In a fixed RF-EH network, the harvested energy is predictable and relatively stable over time due to a fixed distance between the RF source (e.g., Tx device 600) and the EH device (e.g., Rx device 604). For example, using a random multipath fading model, the energy Eⱼ harvested at receiving node j (e.g., Rx device 604) from a transmitting node i (e.g., Tx device 600) is given by:

$${E}_{j} = η {P}_{i} {\vert {ℊ}_{i - j} \vert}^{2} T , \qquad ( Equation 1 )$$

where Pᵢ is the transmit power by transmitting node i, gᵢ₋ⱼ is the channel coefficient of the link between transmitting node i and receiving node j, T is the time allocated for energy harvesting, and η is the RF-to-DC conversion efficiency and is a function of the input power to the EH circuit.

In some examples, the network entity (e.g., the network entity 502 shown in FIG. 5 and/or the Tx device 600 shown in FIG. 6) and UEs (e.g., IoT devices 504a-504d shown in FIG. 5 and/or Rx device 604 shown in FIG. 6) may be configured for simultaneous wireless information and power transfer (SWIPT). SWIPT enables energy-harvesting devices, such as IoT devices, to perform both energy harvesting and information decoding.

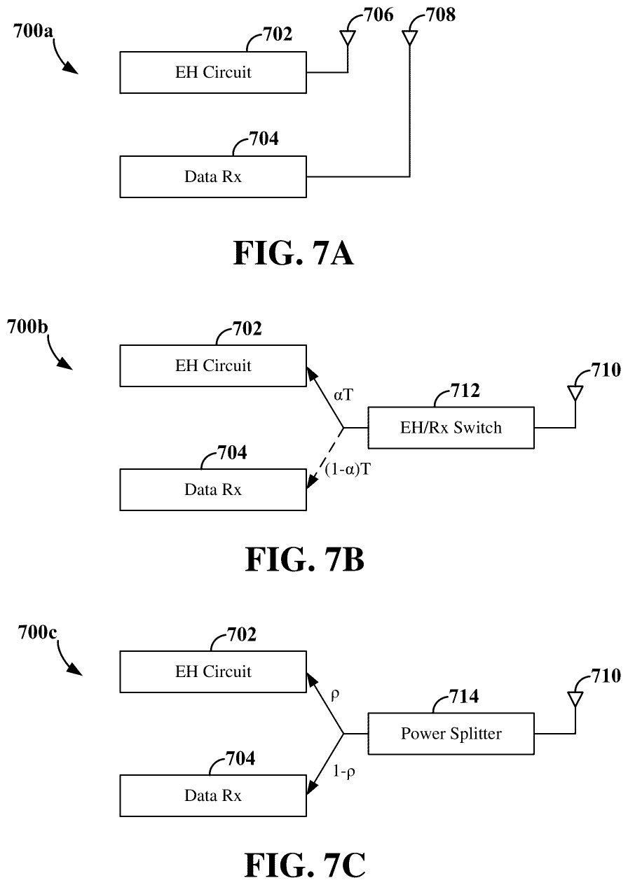

FIGS. 7A, 7B, and 7C are diagrams illustrating examples of energy harvesting receiver architectures 700a, 700b, and 700c, respectively, according to some aspects. Each of the energy harvesting receiver architectures 700a, 700b, and 700c may be implemented, for example, in a receiving device (e.g., a wireless communication device, such as a UE or other IoT device), such as the IoT devices 504a-504d shown in FIG. 5 or the Rx device 604 shown in FIG. 6. In the example shown in FIG. 7A, the energy harvesting receiver architecture 700a is a separated receiver architecture, in which an energy harvesting (EH) circuit 702 is separated from an information receiver (e.g., data Rx) 704. In this example, the EH circuit 702 is configured to receive RF signals via a first set of one or more antenna elements 706 (e.g., antenna elements of an antenna array) and the data Rx 704 is configured to receive RF signals via a second set of one or more antenna elements 708. Thus, in the example shown in FIG. 7A, energy harvesting and data reception and processing (e.g., data decoding and processing) can occur simultaneously using the same received RF signal. In this example, the received RF signal may correspond to an information signal carrying data.

In the example shown in FIG. 7B, the energy harvesting receiver architecture 700b is a time-switching (time-splitting) architecture in which an EH/Rx switch 712 (or transistor) is configured to receive RF signals via a single set of one or more antenna elements 710. The EH/Rx switch 712 is configured to switch, in time, between the EH circuit 702 and the data Rx 704. Thus, the RF signals received via antenna element(s) 710 may be either energy harvested or decoded based on the EH/Rx switch 712. For example, an energy signal may be received during a first time period and an information signal may be received during a second time period following the first time period. Thus, energy harvesting and information decoding may be time division multiplexed (TDM ed). The SW IPT transmitter may be aware of the Rx architecture 700b and transmit the correct signal type (energy or information signal) at each transmission time.

In this example, the energy harvested at receiver j from source/can be calculated as follows:

$${E}_{j} = η {P}_{i} {\vert {ℊ}_{i - j} \vert}^{2} α T , \qquad ( Equation 2 )$$

where 0≤α≤1 is the fraction of time allocated for energy harvesting. In addition, the data rate can be given by:

$${R}_{i - j} = ( 1 - α ) {log}_{2} ( 1 + \frac{{\vert {ℊ}_{i - j} \vert}^{2} {P}_{i}}{κ W} ) , \qquad ( Equation 3 )$$

where κ is the noise spectral density and W denotes the channel bandwidth.

In the example shown in FIG. 7C, the energy harvesting receiver architecture 700c is a power splitting architecture in which a power splitter 714 is configured to receive RF signals via the single set of one or more antenna elements 710. The power splitter 714 is configured to split the power of the received RF signals between the EH circuit 702 and the data Rx 704. Thus, the RF signals received via antenna element(s) 710 may be simultaneously energy harvested and decoded in a power splitting mode. For example, the received RF signal may correspond to an information signal carrying data. In this example, the energy harvested at receiver j from source l can be calculated as follows:

$${E}_{j} = η ρ {P}_{i} {\vert {ℊ}_{i - j} \vert}^{2} T , \qquad ( Equation 4 )$$

where 0≤ρ≤1 is the fraction of power allocated for energy harvesting. Thus, p represents the power splitting factor (power splitting ratio) used to split the power of a received RF signal between the EH circuit 702 and the data Rx 704. The power splitting ratio may be fixed or tunable, depending on the implementation. In addition, the data rate in this example can be given by:

$${R}_{i - j} = {log}_{2} ( 1 + \frac{{\vert {ℊ}_{i - j} \vert}^{2} ( 1 - ρ ) {P}_{i}}{κ W} ) . \qquad ( Equation 5 )$$

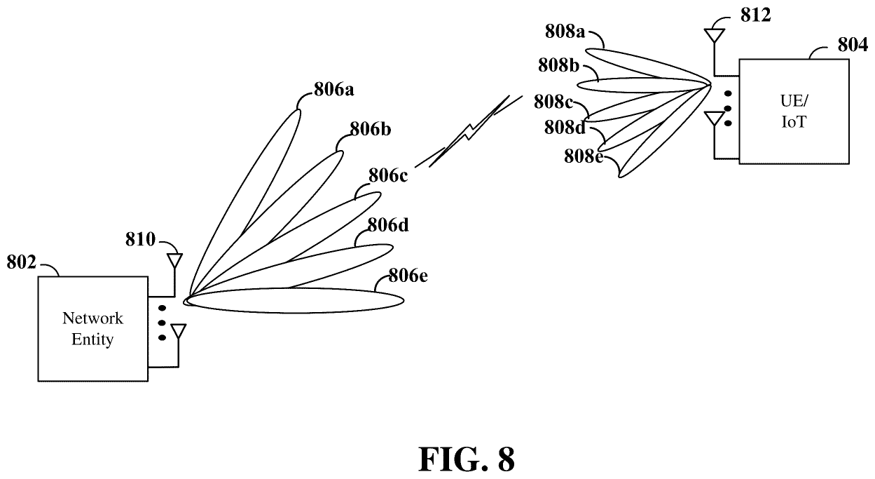

In some examples, beamforming may be introduced in IoT network scenarios, such as SWIPT, to improve the efficiency of energy harvesting and information decoding. FIG. 8 illustrates an example of a wireless communication system supporting beamforming between a network entity 802 and a UE/IoT device 804 according to some aspects. In a beamforming system, the network entity 802 includes multiple antennas 810. The use of such multiple antenna technology enables the wireless communication system to exploit the spatial domain to support spatial multiplexing, beamforming, and transmit diversity.

Beamforming is a signal processing technique that may be used at the network entity 802 and UE/IoT 804 to shape or steer an antenna beam (e.g., a transmit beam or receive beam) along a spatial path between the network entity 802 and the UE/IoT 804. Beamforming may be achieved by combining the signals communicated via antennas 810 (e.g., antenna elements of an antenna array or antenna panel) such that some of the signals experience constructive interference while others experience destructive interference. To create the desired constructive/destructive interference, the network entity 802 may apply amplitude and/or phase offsets to signals transmitted or received from each of the antennas 810. The UE/IoT 804 may further be configured with one or more beamforming antennas 812 (e.g., antenna panels) to transmit and/or receive beamformed signals to and/or from the network entity 802.

In the example shown in FIG. 8, the network entity 802 may be capable of generating one or more transmit/receive beams 806a-806e, each associated with a different spatial direction. In addition, the UE/IoT 804 may be configured to generate a plurality of transit/receive beams 808a-808e, each associated with a different spatial direction. It should be noted that while some beams are illustrated as adjacent to one another, such an arrangement may be different in different aspects. For example, the network entity 802 and UE/IoT 804 may each transmit more or less beams distributed in all directions (e.g., 350 degrees) and in three-dimensions.

The network entity 802 may generally be capable of communicating with the UE/IoT 804 using beams of varying beam widths. In some examples, to select a particular beam for communication with the UE/IoT 804, the network entity 802 may transmit a reference signal, such as a SSB or CSI-RS, on each of a plurality of beams (e.g., beams 806a-806e) in a beam-sweeping manner. In some examples, SSBs may be transmitted on the wider beams, whereas CSI-RSs may be transmitted on the narrower beams. The UE/IoT 804 may measure the reference signal received power (RSRP) or signal-to-interference-plus-noise ratio (SINR) on each of the beams and transmit a beam measurement report (e.g., a Layer 1 (L1) measurement report) to the network entity 802 indicating the RSRP or SINR of one or more of the measured beams. The network entity 802 may then select the particular beam for communication with the UE 804 based on the L1 measurement report.

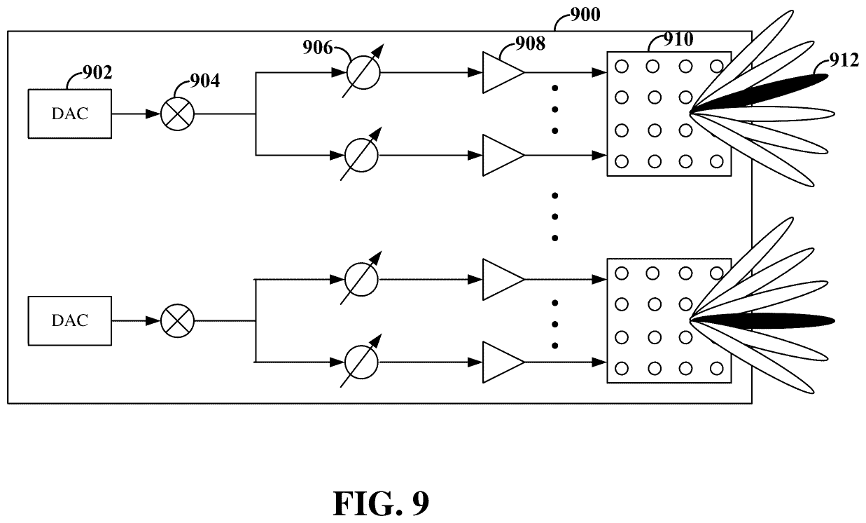

FIG. 9 is a diagram illustrating an example of a transmitter architecture 900 for beamforming according to some aspects. The transmitter architecture 900 may include, for example, one or more digital-to-analog converters (DACs) 902, each configured to receive a respective digital baseband signal and to convert the respective digital baseband signal to an analog baseband signal. Each of the analog baseband signals may be upconverted to an RF signal by respective mixers 904. Each RF signal may then be mapped onto antenna elements of an antenna array 910 via analog phase-shifters 906 and amplified by a respective power amplifier (PA) 908 to produce respective beamformed signals 912 for transmission over-the-air (OTA) to a receiving device. In other examples, digital phase-shifters may be utilized for digital beamforming to produce the beamformed signals 912.

In various aspects of the disclosure, to facilitate beamforming of both energy and information transmissions to an IoT device, the network entity may implement a beam management scheme that takes into account the receiver architecture of the UE/IoT, such as the receiver architectures shown in FIGS. 7A-7C. In some examples, the same beam may be used for both an energy transmission and an information transmission. In this example, the beam management scheme may be considered a fully coupled beam management scheme, which may be applicable, for example, to a power-splitting receiver architecture, such as that shown in FIG. 7C. In other examples, separate energy transmission beams and information transmission beams may be multiplexed in time (e.g., TDMed). In this example, the beam management scheme may be considered a fully decoupled beam management scheme, which may be applicable, for example, to a time-splitting receiver architecture, such as that shown in FIG. 7B.

In still other examples, different spatial division multiplexed beams may be used for energy transmissions and information transmissions during the same time period. In this example, the beam management scheme may be considered a partially coupled beam management scheme, which may be applicable, for example, to a power-splitting architecture, as shown in FIG. 7C. In addition, the partially coupled beam management scheme may facilitate energy and information transmissions to UE groups (e.g., groups of IoT devices). For example, the energy transmission may be provided to two UEs using a wide beam, whereas respective information transmissions may be provided to the two UEs or a different set of UEs using respective narrow beams selected to avoid mutual interference between the UEs.

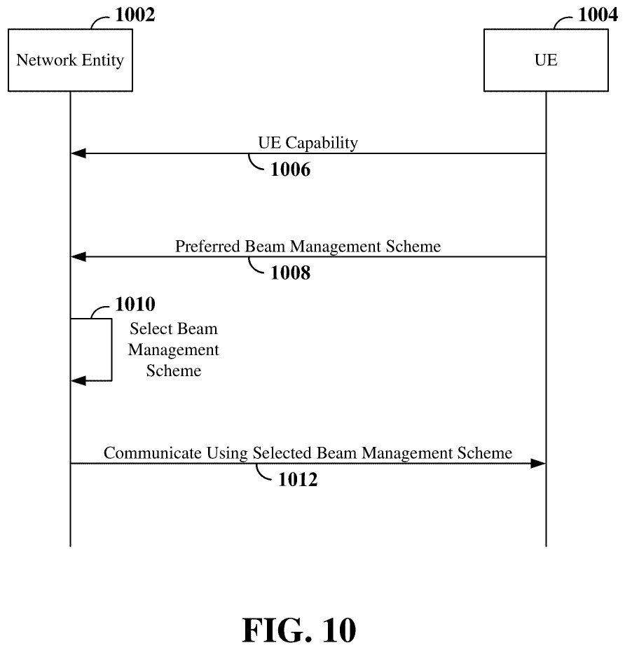

FIG. 10 is a signaling diagram illustrating exemplary signaling for beam management of wireless energy and information transmissions between a network entity 1002 and a UE 1004 (e.g., an IoT device) according to some aspects. The network entity 1002 may correspond, for example, to any of the network entities (e.g., aggregated or disaggregated base stations) shown in any of FIGS. 1, 2, 4-6, and/or 8. The UE 1004 may correspond, for example, to any of the UEs (e.g., IoT devices) shown in any of FIGS. 1, 2, 5, 6, and/or 8.

At 1006, the UE 1004 may transmit a UE capability of the UE 1004 to the network entity 1002. The UE capability may indicate, for example, a receiver architecture of the UE to support both energy harvesting and information decoding. For example, the receiver architecture may correspond to any of the receiver architectures shown in FIGS. 7A-7C.

At 1008, the UE 1004 may optionally further transmit a preferred beam management scheme to the network entity 1002. For example, based on the UE receiver architecture, the UE 1004 may prefer a fully coupled beam management scheme, a fully decoupled beam management scheme, or a partially coupled beam management scheme.

At 1010, the network entity 1002 may select a beam management scheme for communication of energy transmissions and information transmissions to the UE 1004. For example, the network entity 1002 may select the beam management scheme based on the receiver architecture indicated in the UE capability. In some examples, the network entity 1002 may select the beam management scheme further based on the preferred beam management scheme provided by the UE 1004.

For example, the network entity 1002 may select the fully coupled beam management scheme in examples in which the UE capability indicates that the receiver architecture of the UE is a power-splitting receiver architecture, as shown in FIG. 7C. As another example, the network entity 1002 may select the fully decoupled beam management scheme in examples in which the UE capability indicates that the receiver architecture of the UE is a time-splitting receiver architecture, as shown in FIG. 7B, or a separated receiver architecture, as shown in FIG. 7A.

As another example, the network entity 1002 may select the partially coupled beam management scheme in examples in which the UE capability indicates that the receiver architecture of the UE is a power-splitting receiver architecture, as shown in FIG. 7C, or a separated receiver architecture, as shown in FIG. 7A. The network entity 1002 may further consider whether the UE 1004 is included within a group of co-located UEs or non-co-located UEs in selected between the fully coupled and partially coupled beam management schemes. For example, if the UE 1004 is included within a group of co-located UEs, the network entity 1002 may select the fully coupled beam management scheme, whereas if the UE 1004 is included within a group of non-co-located UEs, the network entity 1002 may select the partially coupled beam management scheme. Moreover, the network entity 1002 may select the partially coupled beam management scheme to enable energy harvesting by a first UE group and information decoding by a second UE group, where each UE group includes a different set of UEs. In this example, the UE 1004 may be a member of each UE group or only one of the UE groups.

At 1012, the network entity 1002 may communicate with the UE 1004 using the selected beam management scheme. In some examples, the network entity 1002 may provide an indication of the selected beam management scheme to the UE (e.g., via RRC, MAC-CE or DCI) or may use the preferred beam management scheme provided by the UE.

In examples in which the fully coupled beam management scheme is selected, the network entity 1002 may use the same beam for both an energy transmission and an information transmission to the UE 1004. In some examples, the fully coupled beam management scheme may allow the network entity 1002 to communicate with a group of (co-located) UEs, where the information transmissions are separated in time or frequency. In examples in which the fully decoupled beam management scheme is selected, the network entity 1002 may use separate energy transmission beams and information transmission beams that are multiplexed in time (e.g., TDM ed).

In examples in which the partially coupled beam management scheme is selected, the network entity 1002 may use different beams for energy transmissions and information transmissions that are spatially-division multiplexed during the same time period. In addition, the partially coupled beam management scheme may facilitate energy and information transmissions to UE groups. For example, an energy transmission may be provided to a first group of UEs using a wide beam, whereas respective information transmissions may be provided to the first group of UEs or a different group of UEs using respective narrow beams selected to avoid mutual interference between the UEs. In examples in which the energy transmission and an information transmission are directed towards a same UE (IoT device), the narrow beam may be in a same spatial direction as the wide beam and within a beam width of the wide beam.

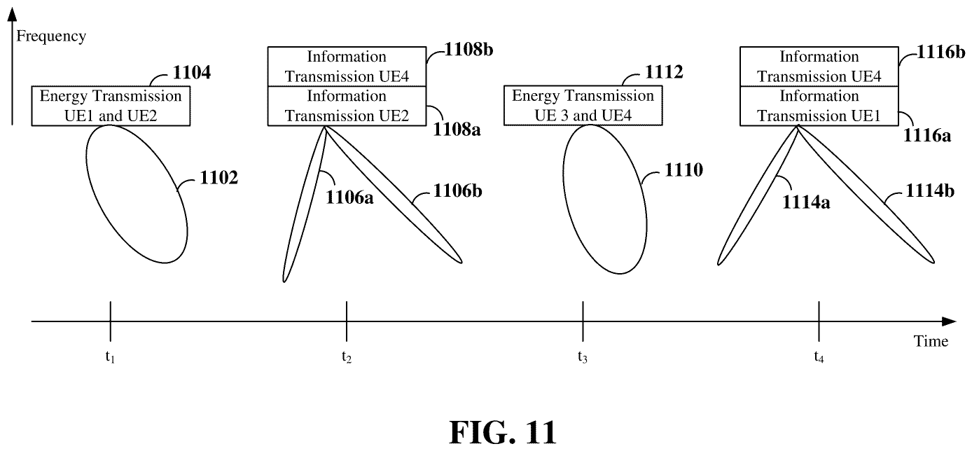

FIG. 11 is a diagram illustrating an example of a fully decoupled beam management scheme according to some aspects. In a fully decoupled beam management scheme, the network entity manages the beams for energy transmissions and information transmissions separately. For example, the energy beam may be selected based on the urgency of energy charging. In an example, the network entity may select the energy beam based on a UE's state-of-charge (SoC) feedback. The information beam may be selected based on the latency requirements of packets to be transmitted to the UE. The fully decoupled beam management scheme may be used, for example, when the UE has a time-splitting receiver architecture, such as that shown in FIG. 7B, or a separated receiver architecture, such as that shown in FIG. 7A.

In the example shown in FIG. 11, at a first time (t₁), the network entity may determine that two UEs (UE1 and UE2) are in a low-energy (low-charge) state and provide an energy transmission 1104 to UE1 and UE2 using beam 1102. At a second time (t₂), the network entity may determine that there are low-latency packets to be transmitted to UE2 and another UE (UE4) and provide respective information transmissions 1108a and 1108b to each of UE2 and UE4 using respective beams 1106a and 1106b. In some examples, the beam 1102 used for energy transmission may be a wide beam, whereas the beams 1106a/1106b used for information transmissions may be narrow beams selected to avoid mutual interference between the information transmissions 1108a and 1108b to UE2 and UE4. Moreover, the respective information transmissions 1108a and 1108b may be separated in frequency to further avoid interference between the information transmissions 1108a and 1108b.

At a third time (t₃), the network entity may determine that two UEs (UE3 and UE4) are in a low-energy (low-charge) state and provide an energy transmission 1112 to UE3 and UE4 using beam 1110. At a fourth time (t₄), the network entity may determine that there are low-latency packets to be transmitted to UE1 and UE4 and provide respective information transmissions 1116a and 1116b to each of UE1 and UE4 using respective beams 1114a and 1114b. Thus, in the example shown in FIG. 11, energy transmissions 1104 and 1112 (energy beams 1102 and 1110) are TDMed with information transmissions 1108a/1108b and 1116a/1116b (information beams 1106a/1106b and 1114a/1114b).

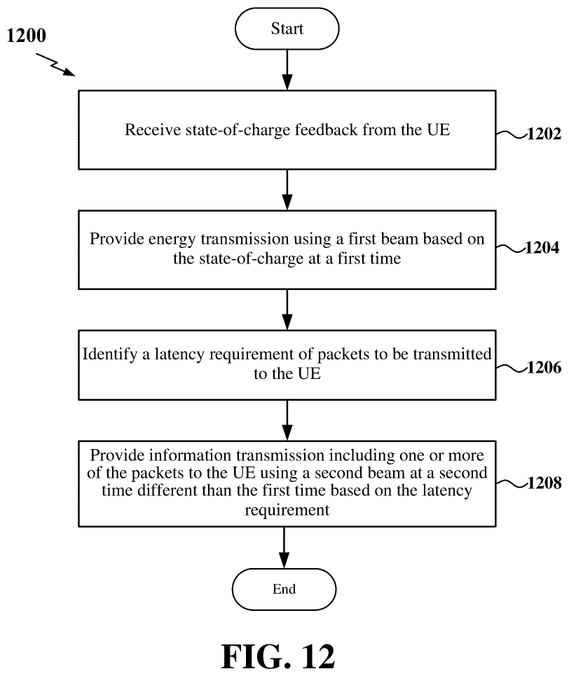

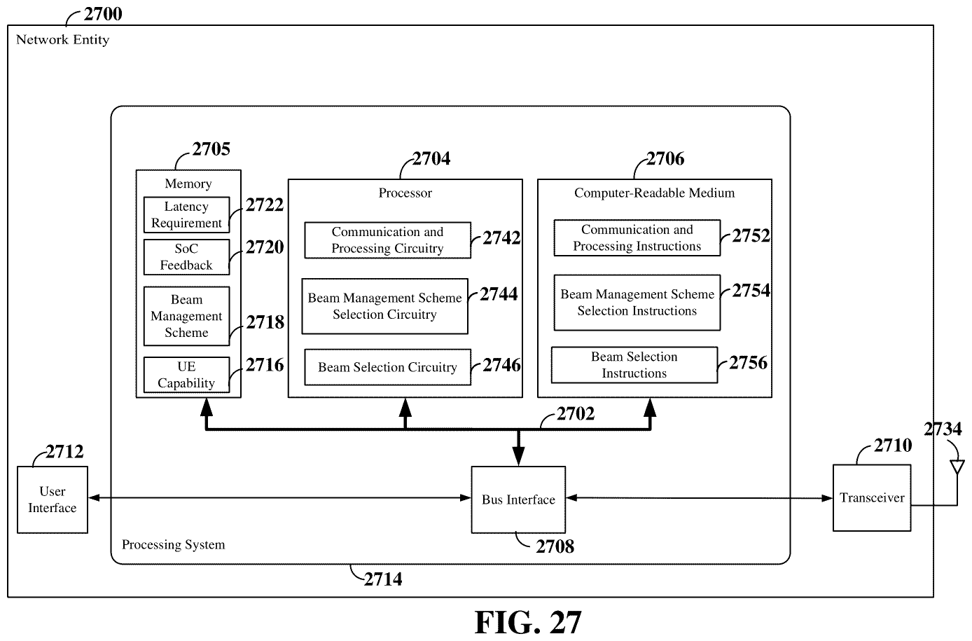

FIG. 12 is a flowchart illustrating an exemplary method for fully decoupled beam management according to some aspects. As described below, some or all illustrated features may be omitted in a particular implementation within the scope of the present disclosure, and some illustrated features may not be required for implementation of all examples. In some examples, the method may be performed by a network entity, such as the network entity shown in FIG. 27, by a processor or processing system, or by any suitable means for carrying out the described functions.

At block 1202, the network entity may receive state-of-charge (SoC) feedback from a UE. At block 1204, based on the SoC indicating a low-energy (low-charge) state, the network entity may provide an energy transmission to the UE using a first beam at a first time. At block 1206, the network entity may further identify a latency requirement of packets (e.g., one or more packets) to be transmitted to the UE. Based on the latency requirement, at 1208, the network entity may provide an information transmission including one or more of the packets to the UE using a second beam at a second time different than the first time of the energy transmission.

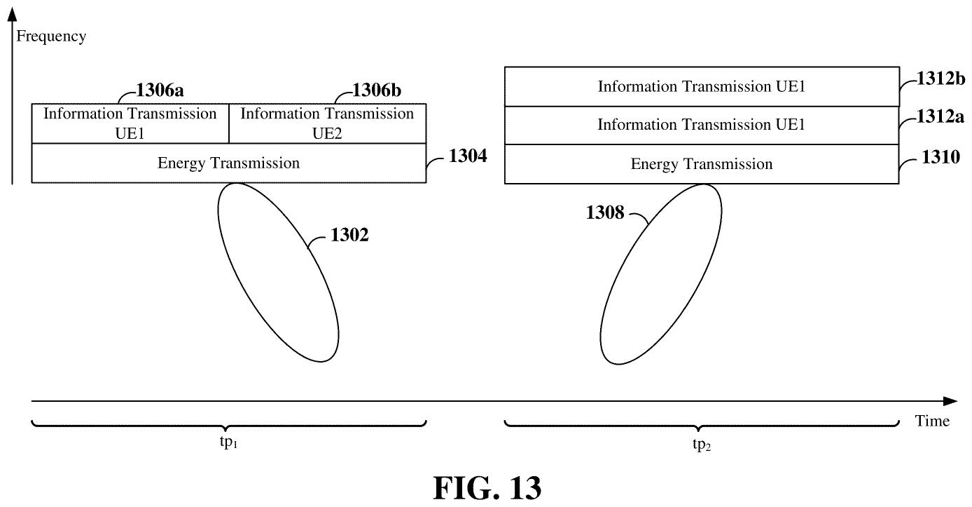

FIG. 13 is a diagram illustrating an example of a fully coupled beam management scheme according to some aspects. In a fully coupled beam management scheme, the network entity manages the beams for energy transmissions and information transmissions jointly. For example, the beam for transmitting the energy transmission and the information transmission may be determined jointly based on the energy state of the UE and latency requirements of the packets to be transmitted to the UE. Fully coupled beam management may further be used with a group of two or more co-located UEs, in which the energy transmission and the respective information transmissions for each of the co-located UEs are superposed, and the respective information transmissions for each of the co-located UEs are separated in time and/or frequency. The fully coupled beam management scheme may be used, for example, when the UE has a power-splitting receiver architecture, such as that shown in FIG. 7C, or a separated receiver architecture, such as that shown in FIG. 7A.

In the example shown in FIG. 13, during a first time period (tp₁), the network entity may determine that two UEs (UE1 and UE2) are in a low-energy (low-charge) state and may further determine that there are low-latency packets to be transmitted to UE1 and UE2. The network entity may then provide an energy transmission 1304 to UE1 and UE2 using beam 1302. In addition, the network entity may provide respective information transmissions 1306a and 1306b to each of UE1 and UE2 using the same beam 1302. The information transmissions 1306a and 1306b may be separated in time (e.g., TDM ed) with one another, such that during a first portion of the energy transmission 1304 (e.g., a first portion of the first time period), the network entity is providing the information transmission 1306a to UE1, and during a second portion of the energy transmission 1304 (e.g., a second portion of the first time period), the network entity is providing the information transmission 1306b to UE2.

During a second time period (tp₂), the network entity may determine that two UEs (UE3 and UE4) are in a low-energy (low-charge) state and may further determine that there are low-latency packets to be transmitted to UE3 and U4. The network entity may then provide an energy transmission 1310 to UE3 and UE4 using beam 1308. In addition, the network entity may provide respective information transmissions 1312a and 1312b to each of UE3 and UE4 using the same beam 1308. The information transmissions 1312a and 1312b may be separated in frequency (e.g., FDMed) with one another, such that the information transmissions 1312a and 1312b are transmitted at the same time during the second time period.

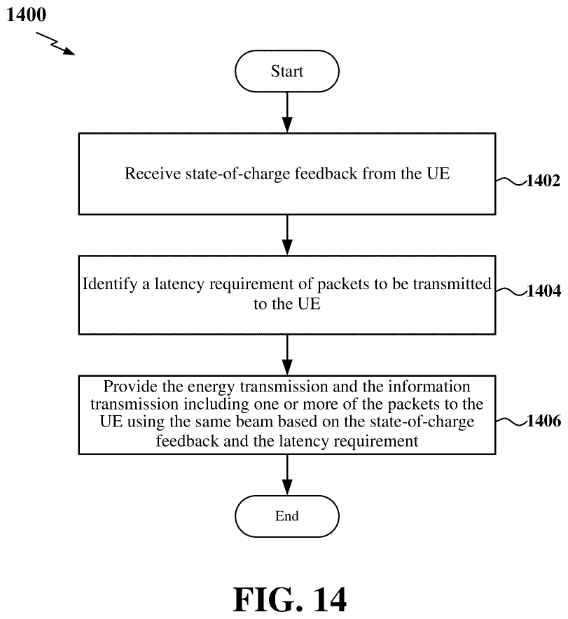

FIG. 14 is a flowchart illustrating an exemplary method for fully coupled beam management according to some aspects. As described below, some or all illustrated features may be omitted in a particular implementation within the scope of the present disclosure, and some illustrated features may not be required for implementation of all examples. In some examples, the method may be performed by a network entity, such as the network entity shown in FIG. 27, by a processor or processing system, or by any suitable means for carrying out the described functions.

At block 1402, the network entity may receive state-of-charge (SoC) feedback from a UE. At block 1404, the network entity may further identify a latency requirement of packets (e.g., one or more packets) to be transmitted to the UE. Based on the state-of-charge feedback and the latency requirement, at 1406, the network entity may provide an energy transmission and an information transmission including one or more of the packets to the UE using a same beam.

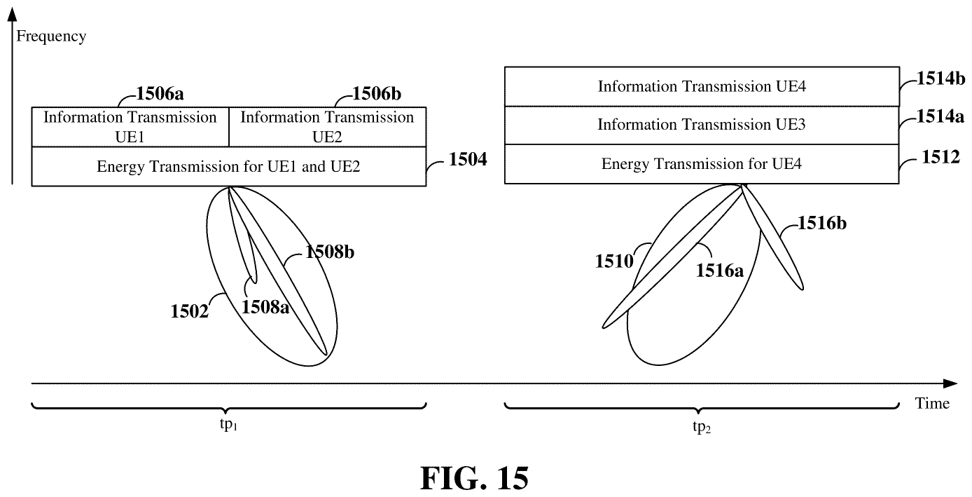

FIG. 15 is a diagram illustrating an example of a partially coupled beam management scheme according to some aspects. In a partially coupled beam management scheme, the network entity manages the beams for energy transmissions and information transmissions both jointly and separately. For example, a wide beam may be used for energy transmission, while narrow beams may be used for information transmission during a same time period. In some examples, the respective beams for energy transmission and information transmission may be determined based on UE groups in which each UE group includes one or more UEs that may be co-located or non-co-located. For example, the energy transmission beam may be determined based on the energy state of a first group of UEs and the respective information beams may be determined based on the latency requirements of the packets to be transmitted to a second group of UEs. In this example, there may be no, partial, or complete overlap between the first group of UEs and the second group of UEs. The partially coupled beam management scheme may be used, for example, when the UE has a power-splitting receiver architecture, such as that shown in FIG. 7C, or a separated receiver architecture, such as that shown in FIG. 7A.

In the example shown in FIG. 15, during a first time period (tp₁), the network entity may determine that two UEs (UE1 and UE2) are in a low-energy (low-charge) state and may further determine that there are low-latency packets to be transmitted to UE1 and UE2. In this example, UE1 and UE2 may form a group of UEs that are co-located. The network entity may then provide an energy transmission 1504 to UE1 and UE2 using beam 1502. In addition, the network entity may provide respective information transmissions 1506a and 1506b to each of UE1 and UE2 using respective additional beams 1508a and 1508b. The information transmissions 1506a and 1506b may be separated in time (e.g., TDM ed) with one another, such that during a first portion of the energy transmission 1504 (e.g., a first portion of the first time period), the network entity is providing the information transmission 1506a to UE1, and during a second portion of the energy transmission 1504 (e.g., a second portion of the first time period), the network entity is providing the information transmission 1506b to UE2. In addition, as shown in FIG. 15, the energy transmission beam 1502 may be a wide beam (e.g., an SSB beam), whereas the respective information transmission beams 1508a and 1508b may be narrow beams (e.g., CSI-RS beams). As further shown in FIG. 15, the narrow beams 1508a and 1508b may be in a same (or similar) direction as and within a beam width of the wide beam 1502 since both UEs are co-located.

During a second time period (tp₂), the network entity may determine that a first group of UEs including a single UE (UE 4) is in a low-energy (low-charge) state and may further determine that there are low-latency packets to be transmitted to a second group of UEs (including UE3 and U4) that are not co-located. The network entity may then provide an energy transmission 1512 to UE4 using beam 1510. In addition, the network entity may provide respective information transmissions 1514a and 1514b to each of UE3 and UE4 using respective information beams 1516a and 1516b. The information transmissions 1514a and 1514b may be separated in frequency (e.g., FDMed) with one another, such that the information transmissions 1514a and 1514b are transmitted at the same time during the second time period. In addition, as shown in FIG. 15, the energy transmission beam 1510 may be a wide beam (e.g., an SSB beam), whereas the respective information transmission beams 1516a and 1516b may be narrow beams (e.g., CSI-RS beams). As further shown in FIG. 15, the narrow beam 1516a may be in a same (or similar) direction as and within a beam width of the wide beam 1510 since both the energy transmission 1512 and the information transmission 1514a are directed to the same UE (e.g., UE4). However, the narrow beam 1516b may be in a different direction with respect to the wide beam 1510 and the other narrow beam 1516a since the two UEs (e.g., UE3 and UE4) are non-co-located.

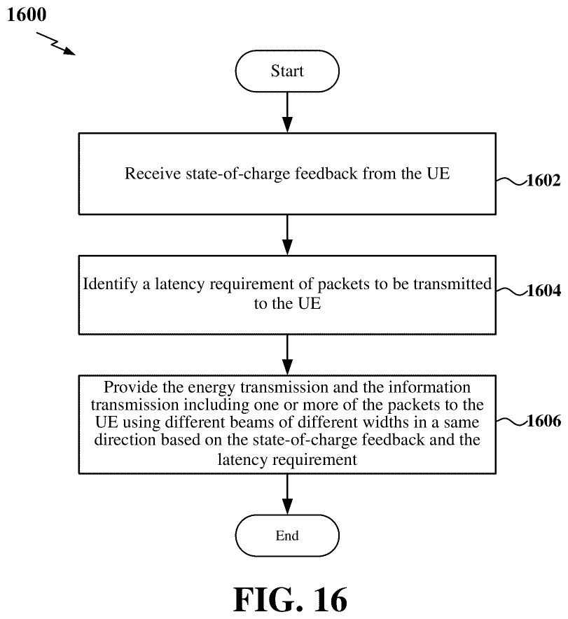

FIG. 16 is a flowchart illustrating an exemplary method for partially coupled beam management according to some aspects. As described below, some or all illustrated features may be omitted in a particular implementation within the scope of the present disclosure, and some illustrated features may not be required for implementation of all examples. In some examples, the method may be performed by a network entity, such as the network entity shown in FIG. 27, by a processor or processing system, or by any suitable means for carrying out the described functions.

At block 1602, the network entity may receive state-of-charge (SoC) feedback from a UE. At block 1604, the network entity may further identify a latency requirement of packets (e.g., one or more packets) to be transmitted to the UE. Based on the state-of-charge feedback and the latency requirement, at 1606, the network entity may provide an energy transmission and an information transmission including one or more of the packets to the UE using different beams of different widths in a same direction. For example, the network entity may provide the energy transmission using a wide beam and the information transmission using a narrow beam within a beam width of the wide beam and in a same (or similar) direction as the wide beam.

Beam failure may occur when the communication link between the network entity and the UE is interrupted on the current beam pair utilized for communication between the network entity and the UE. In some examples, the connection between the network entity and the UE may be able to be reestablished by switching the beam pair used for communication. To facilitate beam switching, a UE may transmit a beam failure report (BFR) to the network entity upon detecting a communication link failure on the current beam pair.

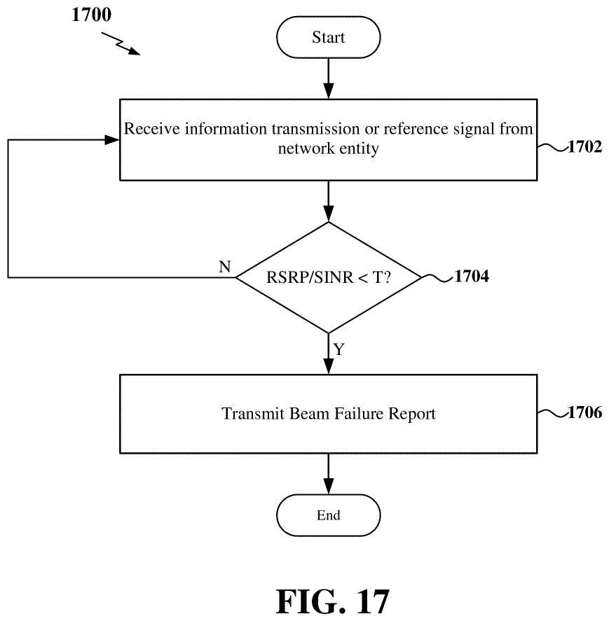

FIG. 17 is a flowchart illustrating an exemplary method for managing a beam failure on a communication link according to some aspects. As described below, some or all illustrated features may be omitted in a particular implementation within the scope of the present disclosure, and some illustrated features may not be required for implementation of all examples. In some examples, the method may be performed by a UE, such as the UEshown in FIG. 29, by a processor or processing system, or by any suitable means for carrying out the described functions.

At block 1702, the UE may receive an information transmission or reference signal (e.g., SSB, CSI-RS, or other dedicated reference signal) from the network entity. At block 1704, the UE may measure the reference signal received power (RSRP) or signal-to-interference-plus-noise ratio (SINR) of the reference signal or information bits of the information transmission or the PDCCH block error rate (BLER), and determine whether the RSRP/SINR of the reference signal or information transmission is less than a threshold (T) or the PDCCH BLER is greater than a threshold. For example, the threshold may be a radio resource control (RRC) configured threshold. As an example, the threshold may correspond to 10% block error rate (BL ER) of a PDCCH. If the RSRP/SINR is less than the threshold (Y branch of block 1704), at block 1706, the UE may generate and transmit a BFR to the network entity. In some examples, the UE may transmit the BFR in response to a configured maximum number of beam failure instances (BFIs) occurring. For example, a medium access control (MAC) layer within the UE may initiate a timer as soon as an initial BFI is reported (e.g., an initial RSRP/SINR measurement is below the threshold or PDCCH BLER above the threshold). The MAC layer may then increment a BFI counter by one for each BFI received during the timer duration. If the configured number of BFIs is reached prior to expiration of the timer, the MAC layer may trigger a beam failure and the UE may generate and transmit the BFR.

However, beam failure determination for energy transfer does not depend upon the measured RSRP/SINR/PDCCH BLER. Instead, beam failure for energy transfer may be based on the energy harvesting efficiency (e.g., energy conversion efficiency). The energy conversion efficiency may be determined, for example, based on the input power of a rectifier and/or the output power of the rectifier in an energy harvesting circuit (e.g., the energy harvesting circuit 606 shown in FIG. 6).

Aspects of the disclosure provide various BFR triggering mechanisms for energy harvesting. Each of the energy harvesting BFR triggering mechanisms may be associated with one or more of the beam management schemes (e.g., fully coupled, fully decoupled, or partially coupled).

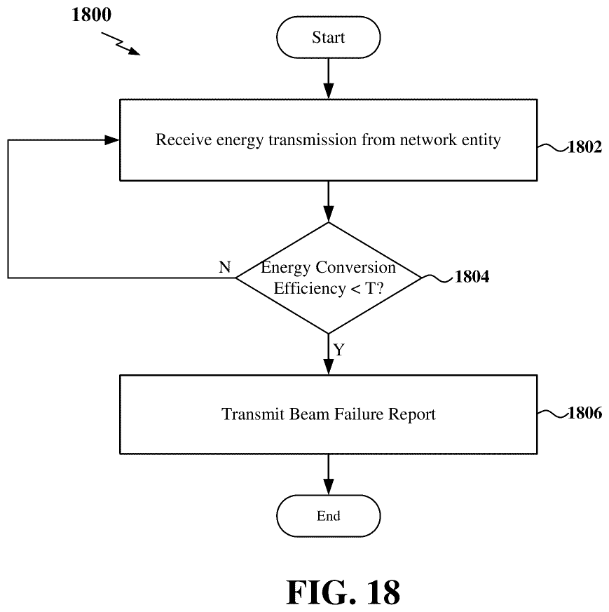

FIG. 18 is a flowchart illustrating an exemplary method for managing a beam failure on an energy harvesting link using a fully decoupled beam management scheme according to some aspects. As described below, some or all illustrated features may be omitted in a particular implementation within the scope of the present disclosure, and some illustrated features may not be required for implementation of all examples. In some examples, the method may be performed by a UE, such as the UEshown in FIG. 29, by a processor or processing system, or by any suitable means for carrying out the described functions. In the example shown in FIG. 18, beam failure management on the communication link using the fully decoupled beam management scheme may be performed according to FIG. 17 or other suitable method.

At block 1802, the UE may receive an energy transmission from the network entity. In the fully decoupled beam management scheme, the energy transmission may be received on a separate beam at a different time than the information transmission, as shown, for example in FIG. 11. At block 1804, the UE may determine whether an energy conversion efficiency (ECE) associated with the energy transmission is less than a threshold (T). The ECE may correspond, for example, to an instantaneous energy conversion efficiency (ECE) of the energy transmission or an ECE over a configured time window (e.g., an average value or maximum value of the ECE during the configured time window). If the energy conversion efficiency associated with the energy transmission is less than the threshold (Y branch of block 1804), at block 1806, the UE may generate and transmit a beam failure report (BFR).

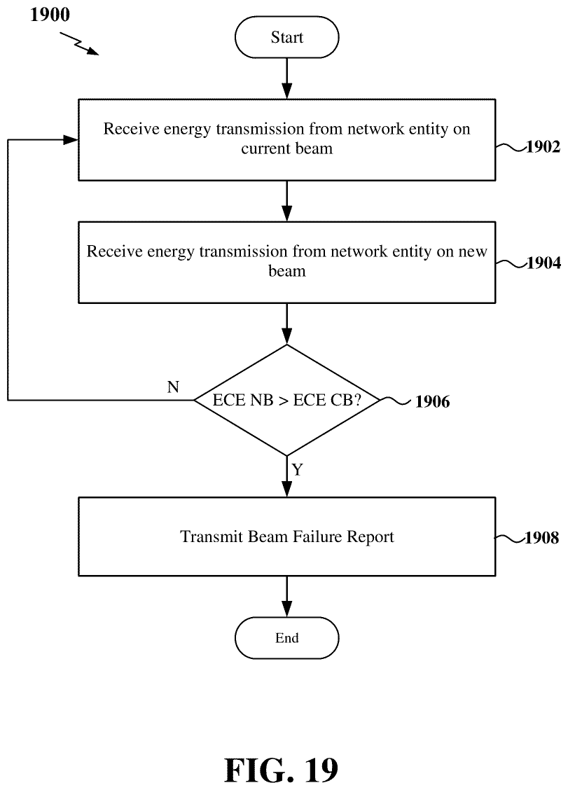

FIG. 19 is a flow chart illustrating another exemplary method for managing a beam failure on an energy harvesting link using a fully decoupled beam management scheme according to some aspects. As described below, some or all illustrated features may be omitted in a particular implementation within the scope of the present disclosure, and some illustrated features may not be required for implementation of all examples. In some examples, the method may be performed by a UE, such as the UEshown in FIG. 29, by a processor or processing system, or by any suitable means for carrying out the described functions. In the example shown in FIG. 19, beam failure management on the communication link using the fully decoupled beam management scheme may be performed according to FIG. 17 or other suitable method.

At block 1902, the UE may receive an energy transmission from the network entity on a current beam. In the fully decoupled beam management scheme, the energy transmission may be received on a separate beam at a different time than the information transmission, as shown, for example in FIG. 11. At block 1904, the UE may receive an additional energy transmission from the network entity on a new beam different than the current beam. At block 1906, the UE may determine whether an energy conversion efficiency (ECE) associated with the additional energy transmission on the new beam (NB) is greater than the energy conversion efficiency associated with the energy transmission on the current beam (CB). Each ECE associated with the current beam and the new beam may correspond, for example, to an instantaneous energy conversion efficiency (ECE) or an ECE over a configured time window (e.g., an average value or maximum value of the ECE during the configured time window). If the energy conversion efficiency associated with the additional energy transmission on the new beam is greater than the energy conversion efficiency associated with the energy transmission on the current beam (Y branch of block 1906), at block 1908, the UE may generate and transmit a beam failure report (BFR).

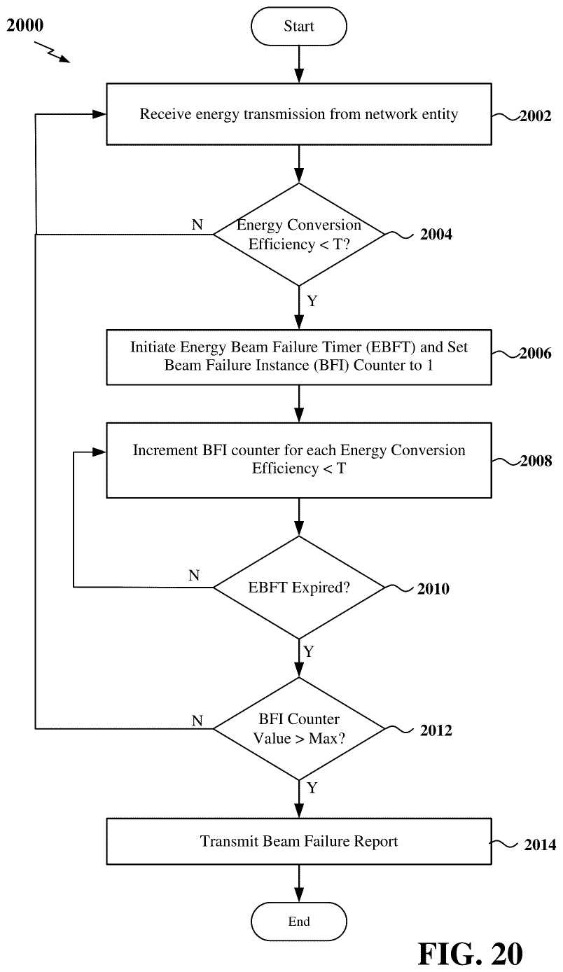

FIG. 20 is a flowchart illustrating another exemplary method for managing a beam failure on an energy harvesting link using a fully decoupled beam management scheme according to some aspects. As described below, some or all illustrated features may be omitted in a particular implementation within the scope of the present disclosure, and some illustrated features may not be required for implementation of all examples. In some examples, the method may be performed by a UE, such as the UEshown in FIG. 29, by a processor or processing system, or by any suitable means for carrying out the described functions. In the example shown in FIG. 20, beam failure management on the communication link using the fully decoupled beam management scheme may be performed according to FIG. 17 or other suitable method.

At block 2002, the UE may receive an energy transmission from the network entity. In the fully decoupled beam management scheme, the energy transmission may be received on a separate beam at a different time than the information transmission, as shown, for example in FIG. 11. At block 2004, the UE may determine whether an energy conversion efficiency (ECE) associated with the energy transmission is less than a threshold (T). In this example, the ECE may correspond to an instantaneous ECE. If the energy conversion efficiency associated with the energy transmission is less than the threshold (Y branch of block 2004), at block 2006, the UE may initiate an energy beam failure timer (EBFT) and set a beam failure instance (BFI) counter equal to 1. At blocks 2008 and 2010, the UE may further increment the BFI counter by one for each subsequent instance of the energy conversion efficiency being less than the threshold prior to expiration of the EBFT. If the EBFT expires (Y branch of block 2010), at block 2012, the UE may determine whether the BFI counter value (e.g., the number of ECE being less than the threshold) is greater than a maximum number (e.g., a threshold). If the BFI counter value is greater than the maximum number (Y branch of block 2012), at block 2014, the UE may generate and transmit a beam failure report (BFR).

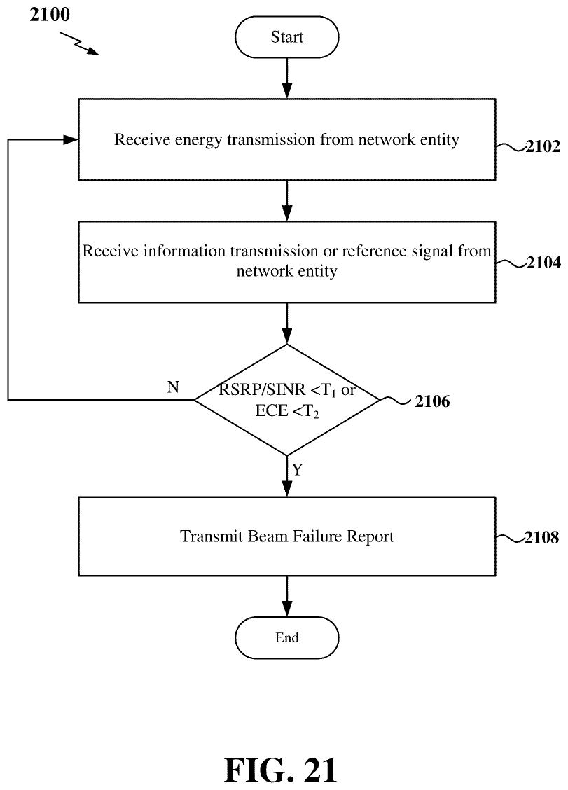

FIG. 21 is a flowchart illustrating an exemplary method for managing a beam failure using a fully coupled beam management scheme or a partially coupled beam management scheme according to some aspects. As described below, some or all illustrated features may be omitted in a particular implementation within the scope of the present disclosure, and some illustrated features may not be required for implementation of all examples. In some examples, the method may be performed by a UE, such as the UEshown in FIG. 29, by a processor or processing system, or by any suitable means for carrying out the described functions.

At block 2102, the UE may receive an energy transmission from the network entity. In addition, at block 2104, the UE may receive an information transmission or reference signal from the network entity. In the fully coupled beam management scheme, the energy transmission and information transmission may be received on the same beam as shown, for example, in FIG. 13. In the partially coupled beam management scheme, the energy transmission and information transmission may be received on separate beams at the same time (e.g., a wide beam for the energy transmission and a narrow beam for the information transmission/reference signal), as shown, for example in FIG. 15.

At block 2106, the UE may determine whether either the RSRP/SINR of the information transmission/reference signal is less than a first threshold (T₁) (or the PDCCH BLER is greater than the first threshold) or whether an energy conversion efficiency (ECE) associated with the energy transmission is less than a second threshold (T₂). The ECE may correspond, for example, to an instantaneous energy conversion efficiency (ECE) of the energy transmission, an ECE over a configured time window (e.g., an average value or maximum value of the ECE during the configured time window), or a number of ECEs during a configured time window exceeding a maximum value. Similarly, the RSRP/SINR/PDCCH BLER may correspond, for example, to an instantaneous RSRP/SINR of the information transmission/reference signal, an RSRP/SINR/PDCCH BLER over a configured time window (e.g., an average value or maximum value of the RSRP/SINR/PDCCH BLER during the configured time window), or a number of RSRPs/SINRs/PDCCH BLERs during a configured time window exceeding a maximum value. If the RSRP/SINR is less than the first threshold (or the PDCCH BLER is greater than the first threshold) or the ECE is less than the second threshold (Y branch of block 2106), at block 2108, the UE may generate and transmit a beam failure report (BFR).

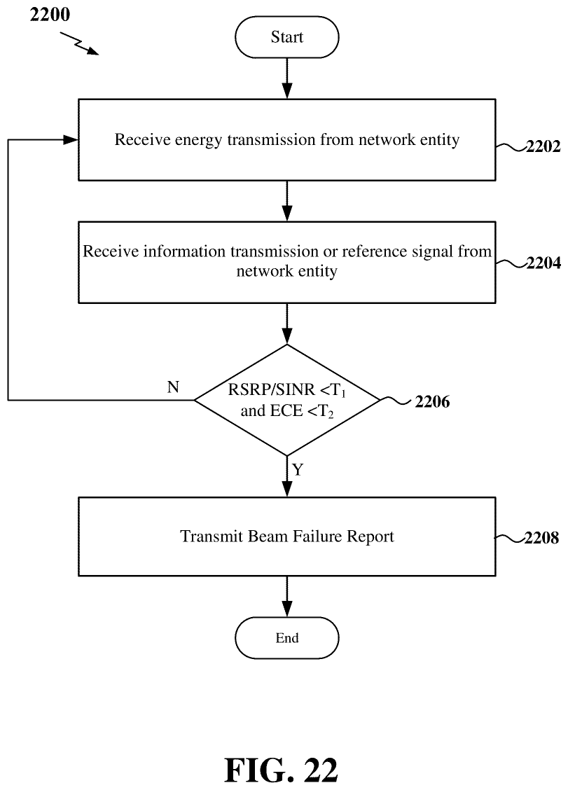

FIG. 22 is a flowchart illustrating an exemplary method for managing a beam failure using a fully coupled beam management scheme or a partially coupled beam management scheme according to some aspects. As described below, some or all illustrated features may be omitted in a particular implementation within the scope of the present disclosure, and some illustrated features may not be required for implementation of all examples. In some examples, the method may be performed by a UE, such as the UEshown in FIG. 29, by a processor or processing system, or by any suitable means for carrying out the described functions.

At block 2202, the UE may receive an energy transmission from the network entity. In addition, at block 2204, the UE may receive an information transmission or reference signal from the network entity. In the fully coupled beam management scheme, the energy transmission and information transmission may be received on the same beam as shown, for example, in FIG. 13. In the partially coupled beam management scheme, the energy transmission and information transmission may be received on separate beams at the same time (e.g., a wide beam for the energy transmission and a narrow beam for the information transmission/reference signal), as shown, for example in FIG. 15.

At block 2206, the UE may determine whether the RSRP/SINR of the information transmission/reference signal is less than a first threshold (T₁) (or whether the PDCCH BLER is greater than the first threshold) and whether an energy conversion efficiency (ECE) associated with the energy transmission is less than a second threshold (T₂). The ECE may correspond, for example, to an instantaneous energy conversion efficiency (ECE) of the energy transmission, an ECE over a configured time window (e.g., an average value or maximum value of the ECE during the configured time window), or a number of ECEs during a configured time window exceeding a maximum value. Similarly, the RSRP/SINR/PDCCH BLER may correspond, for example, to an instantaneous RSRP/SINR/PDCCH BLER of the information transmission/reference signal, an RSRP/SINR/PDCCH BLER over a configured time window (e.g., an average value or maximum value of the RSRP/SINR/PDCCH BLER during the configured time window), or a number of RSRPs/SINRs/PDCCH BLERs during a configured time window exceeding a maximum value. If both the RSRP/SINR is less than the first threshold (or the PDCCH BLER is greater than the first threshold) and the ECE is less than the second threshold (Y branch of block 2206), at block 2208, the UE may generate and transmit a beam failure report (BFR).

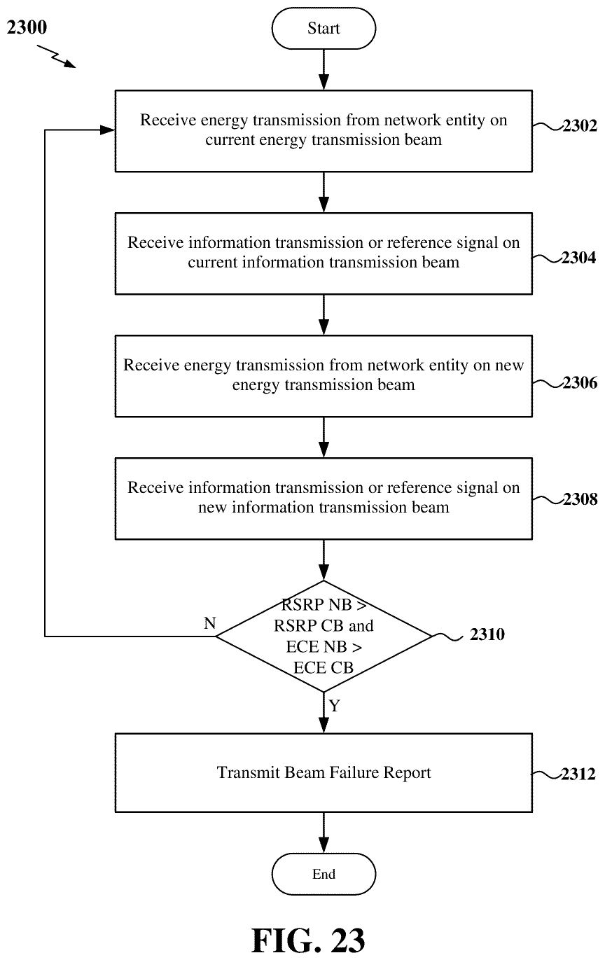

FIG. 23 is a flowchart illustrating an exemplary method for managing a beam failure using a fully coupled beam management scheme or a partially coupled beam management scheme according to some aspects. As described below, some or all illustrated features may be omitted in a particular implementation within the scope of the present disclosure, and some illustrated features may not be required for implementation of all examples. In some examples, the method may be performed by a UE, such as the UEshown in FIG. 29, by a processor or processing system, or by any suitable means for carrying out the described functions.

At block 2302, the UE may receive an energy transmission from the network entity on a current energy transmission beam. In addition, at block 2304, the UE may receive an information transmission or reference signal from the network entity on a current information transmission beam. In the fully coupled beam management scheme, the energy transmission and information transmission may be received on the same beam as shown, for example, in FIG. 13. In the partially coupled beam management scheme, the energy transmission and information transmission may be received on separate beams at the same time (e.g., a wide beam for the energy transmission and a narrow beam for the information transmission/reference signal), as shown, for example in FIG. 15.

At block 2306, the UE may receive an additional energy transmission from the network entity on a new energy transmission beam. In addition, at block 2308, the UE may receive an additional information transmission or reference signal from the network entity on a new information transmission beam. As with the current beams, in the fully coupled beam management scheme, the additional energy transmission and additional information transmission may be received on the same beam as shown, for example, in FIG. 13. In the partially coupled beam management scheme, the additional energy transmission and additional information transmission may be received on separate beams at the same time (e.g., a wide beam for the energy transmission and a narrow beam for the information transmission/reference signal), as shown, for example in FIG. 15.

At block 2310, the UE may determine whether the RSRP/SINR of the additional information transmission/reference signal on the new information transmission beam (NB) is greater than the RSRP/SINR of the information transmission on the current information transmission beam (CB). In addition, the UE may determine whether an energy conversion efficiency (ECE) associated with the additional energy transmission on the new energy transmission beam (NB) is greater than the energy conversion efficiency (ECE) associated with the energy transmission on the current energy transmission beam (CB). Again, each ECE may correspond, for example, to an instantaneous energy conversion efficiency (ECE) of the energy transmission, an ECE over a configured time window (e.g., an average value or maximum value of the ECE during the configured time window), or a number of ECEs during a configured time window exceeding a maximum value. Similarly, each RSRP/SINR may correspond, for example, to an instantaneous RSRP/SINR of the information transmission/reference signal, an RSRP/SINR over a configured time window (e.g., an average value or maximum value of the RSRP/SINR during the configured time window), or a number of RSRPs/SINRs during a configured time window exceeding a maximum value. If both the RSRP/SINR of the NB is greater than the RSRP/SINR of the CB and the ECE of the NB is greater than the ECE of the CB (Y branch of block 2310), at block 2312, the UE may generate and transmit a beam failure report (BFR).

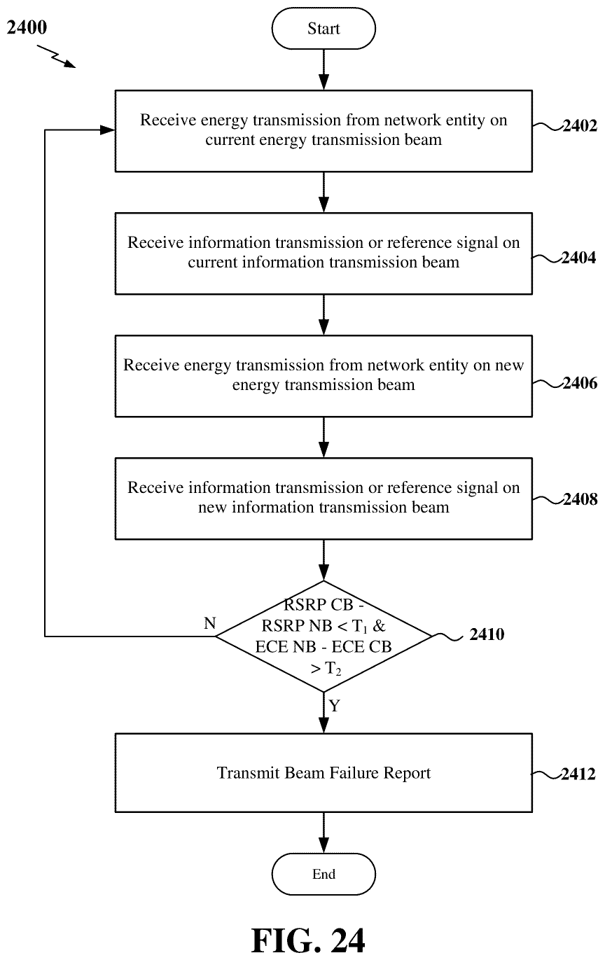

FIG. 24 is a flowchart illustrating an exemplary method for managing a beam failure using a fully coupled beam management scheme or a partially coupled beam management scheme according to some aspects. As described below, some or all illustrated features may be omitted in a particular implementation within the scope of the present disclosure, and some illustrated features may not be required for implementation of all examples. In some examples, the method may be performed by a UE, such as the UEshown in FIG. 29, by a processor or processing system, or by any suitable means for carrying out the described functions.

At block 2402, the UE may receive an energy transmission from the network entity on a current energy transmission beam. In addition, at block 2404, the UE may receive an information transmission or reference signal from the network entity on a current information transmission beam. In the fully coupled beam management scheme, the energy transmission and information transmission may be received on the same beam as shown, for example, in FIG. 13. In the partially coupled beam management scheme, the energy transmission and information transmission may be received on separate beams at the same time (e.g., a wide beam for the energy transmission and a narrow beam for the information transmission/reference signal), as shown, for example in FIG. 15.

At block 2406, the UE may receive an additional energy transmission from the network entity on a new energy transmission beam. In addition, at block 2408, the UE may receive an additional information transmission or reference signal from the network entity on a new information transmission beam. As with the current beams, in the fully coupled beam management scheme, the additional energy transmission and additional information transmission may be received on the same beam as shown, for example, in FIG. 13. In the partially coupled beam management scheme, the additional energy transmission and additional information transmission may be received on separate beams at the same time (e.g., a wide beam for the energy transmission and a narrow beam for the information transmission/reference signal), as shown, for example in FIG. 15.

At block 2410, the UE may determine whether a difference between the RSRP/SINR of the information transmission/reference signal on the current information transmission beam (CB) and the RSRP/SINR of the additional information transmission on the new information transmission beam (NB) is less than a first threshold (T₁). In addition, the UE may determine whether a difference between an energy conversion efficiency (ECE) associated with the additional energy transmission on the new energy transmission beam (NB) and the energy conversion efficiency (ECE) associated with the energy transmission on the current energy transmission beam (CB) is greater than a second threshold (T₂). A gain, each ECE may correspond, for example, to an instantaneous energy conversion efficiency (ECE) of the energy transmission, an ECE over a configured time window (e.g., an average value or maximum value of the ECE during the configured time window), or a number of ECEs during a configured time window exceeding a maximum value. Similarly, each RSRP/SINR may correspond, for example, to an instantaneous RSRP/SINR of the information transmission/reference signal, an RSRP/SINR over a configured time window (e.g., an average value or maximum value of the RSRP/SINR during the configured time window), or a number of RSRPs/SINRs during a configured time window exceeding a maximum value.

If both the difference between the RSRP/SINR of the CB and the RSRP/SINR of the NB is less than the first threshold and the difference between the ECE of the NB and the ECE of the CB is greater than the second threshold (Y branch of block 2410), at block 2412, the UE may generate and transmit a beam failure report (BFR). In this example, the RSRP/SINR of the new information transmission beam is worse than the current information transmission beam, but the difference between the RSRP/SINRs of the two beams is small (e.g., less than the first threshold). In addition, the ECE of the new energy transmission beam is much better than the ECE of the current energy transmission beam (e.g., the difference between the ECEs of the two beams is greater than the second threshold).

In other examples, the UE may generate and transmit a BFR if the opposite occurs. For example, if both the difference between the RSRP/SINR of the NB and the RSRP/SINR of the CB is greater than a first threshold (e.g., indicating the RSRP/SINR of the NB is much better than the CB) and the difference between the ECE of the CB and the ECE of the NB is less than a second threshold (e.g., indicating the ECE of the NB is slightly worse than that of the CB).

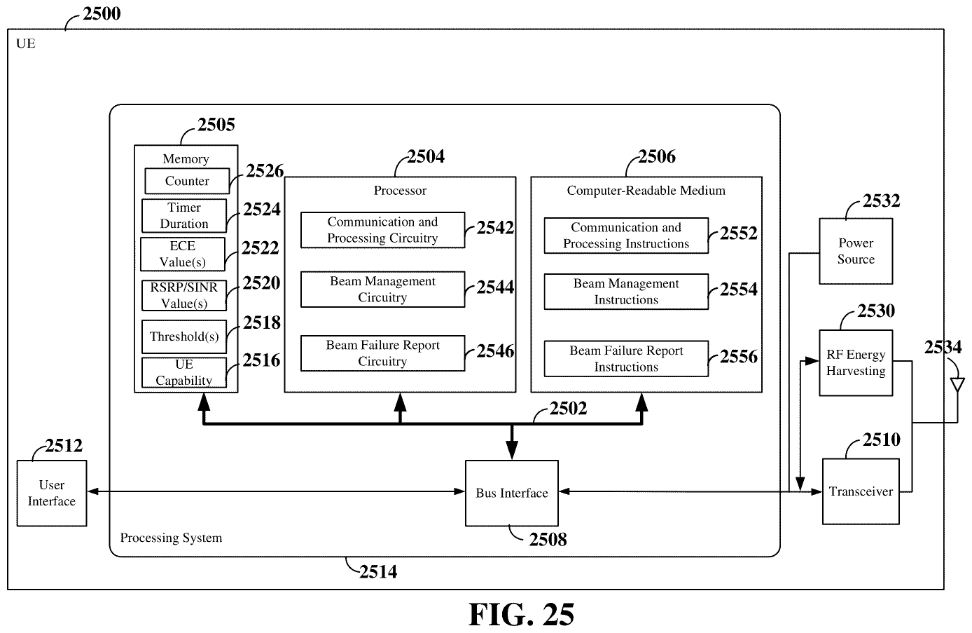

FIG. 25 is a block diagram illustrating an example of a hardware implementation for a user equipment (UE) 2500 employing a processing system 2514. For example, the UE 2500 may correspond to an IoT device or any other UE, as shown and described above in reference to FIGS. 1, 2, 5, 6, 8, and/or 10, and may include the circuitry shown in any of FIGS. 7A-7C.

The UE 2500 may be implemented with a processing system 2514 that includes one or more processors 2504. Examples of processors 2504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the UE 2500 may be configured to perform any one or more of the functions described herein. That is, the processor 2504, as utilized in the UE 2500, may be used to implement any one or more of the processes and procedures described below.

The processor 2504 may in some instances be implemented via a baseband or modem chip and in other implementations, the processor 2504 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 2514 may be implemented with a bus architecture, represented generally by the bus 2502. The bus 2502 may include any number of interconnecting buses and bridges depending on the specific application of the processing system 2514 and the overall design constraints. The bus 2502 links together various circuits including one or more processors (represented generally by the processor 2504), a memory 2505, and computer-readable media (represented generally by the computer-readable medium 2506). The bus 2502 may also link various other circuits such as timing sources, peripherals, voltage regulators, and power management circuits, which are well known in the art, and therefore, will not be described any further.

A bus interface 2508 provides an interface between the bus 2502, a transceiver 2510, an RF energy harvesting circuit 2530, and a power source 2532. The transceiver 2510 provides a means for communicating with various other apparatus over a transmission medium (e.g., air interface) via at least one antenna 2534 (e.g., at least one antenna array). The RF energy harvesting circuit 2530 provides a means for harvesting energy from RF signals (e.g., received transmissions) received via the at least one antenna 2534. In some examples, the RF energy harvesting circuit 2530 may correspond to the EH circuit 702 shown in any of FIGS. 7A-7C and the transceiver 2510 may include the data receiver (Rx) 704 shown in any of FIGS. 7A-7C. In some examples, the UE 2500 may further include an EH/Rx switch and/or power splitter (not shown for convenience) for time-splitting and/or power-splitting between the EH circuit and the data Rx. The power source 2532 provides a means for supplying power to various components in the UE 2500 and may be charged by the RF energy harvesting circuit 2530. Depending upon the nature of the apparatus, a user interface 2512 (e.g., keypad, display, touch screen, speaker, microphone, control knobs, etc.) may also be provided. Of course, such a user interface 2512 is optional, and may be omitted in some examples.

The processor 2504 is responsible for managing the bus 2502 and general processing, including the execution of software stored on the computer-readable medium 2506. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software, when executed by the processor 2504, causes the processing system 2514 to perform the various functions described below for any particular apparatus. The computer-readable medium 2506 and the memory 2505 may also be used for storing data that is utilized by the processor 2504 when executing software. For example, the memory 2505 may store one or more of a UE capability 2516, one or more thresholds 2518, one or more RSRP/SINR values 2520, one or more energy conversion efficiency (ECE) values, a timer duration 2524, and/or a counter 2526.

The computer-readable medium 2506 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 2506 may reside in the processing system 2514, external to the processing system 2514, or distributed across multiple entities including the processing system 2514. The computer-readable medium 2506 may be embodied in a computer program product. By way of example, a computer program product may include a computer-readable medium in packaging materials. In some examples, the computer-readable medium 2506 may be part of the memory 2505. Those skilled in the art will recognize how best to implement the described functionality presented throughout this disclosure depending on the particular application and the overall design constraints imposed on the overall system.

In some aspects of the disclosure, the processor 2504 may include circuitry configured for various functions. For example, the processor 2504 may include communication and processing circuitry 2542, configured to communicate with a network entity (e.g., an aggregated or disaggregated base station, such as a gNB or eNB) via a Uu link. In some examples, the communication and processing circuitry 2542 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 2542 may include one or more transmit/receive chains.

In some implementations where the communication involves receiving information, the communication and processing circuitry 2542 may obtain information from a component of the UE 2500 (e.g., from the transceiver 2510 that receives the information via radio frequency signaling or some other type of signaling suitable for the applicable communication medium), process (e.g., decode) the information, and output the processed information. For example, the communication and processing circuitry 2542 may output the information to another component of the processor 2504, to the memory 2505, or to the bus interface 2508. In some examples, the communication and processing circuitry 2542 may receive one or more of signals, messages, other information, or any combination thereof. In some examples, the communication and processing circuitry 2542 may receive information via one or more channels. In some examples, the communication and processing circuitry 2542 may include functionality fora means for receiving. In some examples, the communication and processing circuitry 2542 may include functionality for a means for processing, including a means for demodulating, a means for decoding, etc.

In some implementations where the communication involves sending (e.g., transmitting) information, the communication and processing circuitry 2542 may obtain information (e.g., from another component of the processor 2504, the memory 2505, or the bus interface 2508), process (e.g., modulate, encode, etc.) the information, and output the processed information. For example, the communication and processing circuitry 2542 may output the information to the transceiver 2510 (e.g., that transmits the information via radio frequency signaling or some other type of signaling suitable for the applicable communication medium). In some examples, the communication and processing circuitry 2542 may send one or more of signals, messages, other information, or any combination thereof. In some examples, the communication and processing circuitry 2542 may send information via one or more channels. In some examples, the communication and processing circuitry 2542 may include functionality for a means for sending (e.g., a means for transmitting). In some examples, the communication and processing circuitry 2542 may include functionality for a means for generating, including a means for modulating, a means for encoding, etc.

The communication and processing circuitry 2542 may be configured to transmit, via the transceiver 2510, the UE capability 2516 to the network entity. The UE capability may indicate, for example, a receiver architecture of the UE to support energy harvesting and information decoding. For example, the receiver architecture may correspond to a separate receiver architecture, a time-splitting receiver architecture, or a power-splitting receiver architecture. The communication and processing circuitry 2542 may further be configured to communicate with the network entity using a beam management scheme based on the UE capability. For example, the beam management scheme may include one or more beams (e.g., network entity side beams) for providing an energy transmission and an information transmission to the UE. The communication and processing circuitry 2542 may further be configured to transmit an indication of a preferred beam management scheme to the network entity. In this example, the beam management scheme may correspond to the preferred beam management scheme.

In some examples, the communication and processing circuitry 2542 may further be configured to transmit a beam failure report to the network entity. The communication and processing circuitry 2542 may further be configured to execute communication and processing instructions (software) 2552 stored in the computer-readable medium 2506 to implement one or more of the functions described herein.

The processor 2504 may further include beam management circuitry 2544, configured to identify the beam management scheme utilized for communication with the network entity (e.g., based on an indication received from the network entity or based on the preferred beam management scheme provided by the UE) and to control the RF energy harvesting circuit 2530 and transceiver 2510 based on the beam management scheme to receive an energy transmission and an information transmission from the network entity. For example, the beam management circuitry 2544 may be configured to control a switch (e.g., an EH/Rx switch) or a power splitter (not shown for convenience) to receive an energy transmission and an information transmission on the same beam (e.g., a network entity beam or beam pair) or different beams.

In some examples, the beam management scheme may include a fully decoupled beam management scheme that includes a first beam for the energy transmission and a second beam for the information transmission. In this example, the first beam and the second beam are time division multiplexed. The fully decoupled beam management scheme may be used, for example, in response to the UE capability 2516 indicating that the UE includes a time-splitting receiver architecture.

In some examples, the beam management scheme may include a fully coupled beam management scheme that includes a same beam for both the energy transmission and the information transmission. The fully coupled beam management scheme may be used, for example, in response to the UE capability 2516 indicating that the UE includes a power-splitting receiver architecture supporting a superposition of the energy transmission and the information transmission.

In some examples, the beam management scheme may include a partially coupled beam management scheme that includes a first beam for the energy transmission and a second beam for the information transmission during a same time period. In some examples, the first beam may include a wide beam and the second beam may include a narrow beam. In some examples, the narrow beam may be in a same direction as the wide beam and within a beam width of the wide beam. The partially coupled beam management scheme may be used, for example, in response to the UE capability 2516 indicating that the UE includes a power-splitting receiver architecture. The beam management circuitry 2544 may further be configured to execute beam management instructions (software) 2554 stored in the computer-readable medium 2506 to implement one or more of the functions described herein.

The processor 2504 may further include beam failure report circuitry 2546, configured to generate a beam failure report (BFR) and to operate together with the communication and processing circuitry 2542 and transceiver 2510 to transmit the BFR to the network entity. For example, the beam failure report circuitry 2546 may be configured to generate and transmit a beam failure report to the network entity based on the beam management scheme utilized for communication with the network entity.

In examples in which the beam management scheme is a fully decoupled beam management scheme, the beam failure report circuitry 2546 may be configured to measure the energy conversion efficiency of the received energy transmission on the first beam to produce an ECE value 2522 and store the ECE value 2522 in memory 2505. The beam failure report circuitry 2546 may further be configured to compare the ECE value 2522 to a threshold (e.g., one of the thresholds 2518 stored in memory 2505) and to generate and transmit a BFR to the network entity in response to the energy conversion efficiency (ECE value 2522) of the first beam being less than the threshold 2518. In some examples, the ECE value 2522 is an average energy conversion efficiency over a time window or a maximum energy conversion efficiency during the time window.

In some examples, the beam failure report circuitry 2546 may be configured to initiate a beam failure indication timer with, for example, the timer duration 2524 stored in memory 2505 upon determining that an ECE value 2522 is less than the threshold 2518. The beam failure report circuitry 2546 may further be configured to increment the counter 2526 stored in memory 2505 for each of a plurality of ECE values obtained during the timer duration 2524 that are less than the threshold 2518. The beam failure report circuitry 2546 may further be configured to generate and transmit a BFR to the network entity in response to the number of the plurality of energy conversion efficiency values that are less than the threshold at the expiration of the energy beam failure indication timer (e.g., the counter 2526 value) being greater than a maximum number (e.g., one of the thresholds 2518).

In some examples, the beam failure report circuitry 2546 may be configured to measure a first ECE (e.g., one of the ECE values 2522) of a new beam and a second ECE (e.g., one of the ECE values 2522) of the first beam. In this example, the beam failure report circuitry 2546 may be configured to generate and transmit a BFR to the network entity in response to the first ECE 2522 of the new beam being greater than the second ECE 2522 of the first beam. In some examples, the first ECE is a first average ECE of the new beam over a time window and the second ECE is a second average ECE of the first beam over the time window. In this example, the beam failure report circuitry 2546 may be configured to generate and transmit the BFR to the network entity in response to the first average ECE 2522 of the new beam over the time window being greater than the second average ECE 2522 of the first beam over the time window.

In examples in which the beam management scheme is a fully coupled beam management scheme or a partially coupled beam management scheme, the beam failure report circuitry 2546 may be configured to measure (obtain) an RSRP or SINR (e.g., one of the RSRP/SINR values 2520 stored in memory) (or PDCCH BLER) associated with the information transmission. In some examples, the beam failure report circuitry 2546 may further be configured to generate and transmit a BFR to the network entity in response to either an RSRP 2520 associated with the information transmission being less than a first threshold (e.g., one of the thresholds 2518) or an energy conversion efficiency (e.g., one of the ECE values 2522) of the energy transmission being less than a second threshold (e.g., one of the thresholds 2518). In other examples, the beam failure report circuitry 2546 may be configured to generate and transmit a BFR to the network entity in response to both the RSRP 2520 associated with the information transmission being less than the first threshold 2518 and the ECE 2522 of the energy transmission being less than the second threshold.

In some examples, the beam failure report circuitry 2546 may be configured to measure (obtain) an additional RSRP or SINR (e.g., one of the RSRP/SINR values 2520) associated with a new information beam and an additional ECE (e.g., one of the ECE values 2522) associated with a new energy beam. In this example, the beam failure report circuitry 2546 may be configured to generate and transmit the BFR in response to both the additional RSRP 2520 associated with the new information beam being greater than the RSRP 2520 associated with the information transmission and the additional ECE 2522 associated with a new energy beam being greater than the ECE 2522 of the energy transmission.

In some examples, the beam failure report circuitry 2546 may be configured to measure (obtain) a first ECE (e.g., one of the ECE values 2522) of a first new beam and a second ECE (e.g., one of the ECE values 2522) of a first current beam (e.g., which may correspond to the same beam used for energy and information transmission in the fully coupled beam management scheme or the wide beam in the partially coupled beam management scheme). In addition, the beam failure report circuitry 2546 may be configured to measure (obtain) a first RSRP (e.g., one of the RSRP/SINR values 2520) of a second current beam (e.g., which may correspond to the same beam in the fully coupled beam management scheme or the narrow beam in the partially coupled beam management scheme) and a second RSRP (e.g., one of the RSRP/SINR values 2520) of a second new beam.

In some examples, the beam failure report circuitry 2546 may be configured to generate and transmit the BFR to the network entity in response to a first difference between the first ECE 2522 of the first new beam and the second ECE of the first current beam being greater than a first threshold (e.g., one of the thresholds 2518) and a second difference between the first RSRP 2520 of the second current beam and the second RSRP 2520 of the second new beam being less than a second threshold (e.g., one of the thresholds 2518). In this example, the first RSRP 2520 is less than the second RSRP 2520.

In other examples, the beam failure report circuitry 2546 may be configured to generate and transmit the BFR to the network entity in response to a third difference between the second ECE 2522 of the first current beam and the first ECE 2522 of the first new beam being less than a third threshold (e.g., one of the thresholds 2518) and a fourth difference between the second RSRP of the second new beam and the first RSRP of the second current beam being greater than a second threshold (e.g., one of the thresholds 2518). In this example, the first ECE 2522 is less than the second ECE 2522. The beam failure report circuitry 2546 may further be configured to execute beam failure report instructions (software) 2556 stored in the computer-readable medium 2506 to implement one or more of the functions described herein.

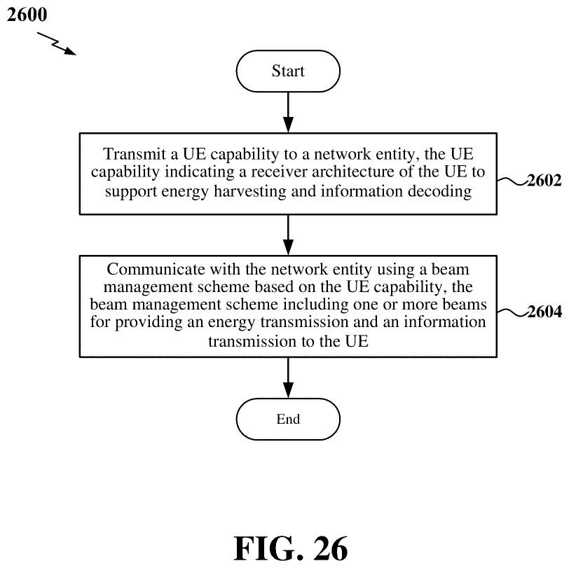

FIG. 26 is a flow chart of an exemplary method 2600 for beam management for wireless energy transfer according to some aspects. As described below, some or all illustrated features may be omitted in a particular implementation within the scope of the present disclosure, and some illustrated features may not be required for implementation of all examples. In some examples, the method may be performed by the UE 2500, as described above and illustrated in FIG. 25, by a processor or processing system, or by any suitable means for carrying out the described functions.

At block 2602, the UE (e.g., an IoT device or other UE) may transmit a UE capability to a network entity, in which the UE capability indicates a receiver architecture of the UE to support energy harvesting and information decoding. For example, the communication and processing circuitry 2542, together with the transceiver 2510 and antenna 2534, shown and described above in connection with FIG. 25, may provide a means to transmit the UE capability.

At block 2604, the UE may communicate with the network entity using a beam management scheme based on the UE capability. The beam management scheme includes one or more beams for providing an energy transmission and an information transmission from the network entity to the UE. In some examples, the UE may further transmit an indication of a preferred beam management scheme to the network entity. In this example, the the beam management scheme can correspond to the preferred beam management scheme. For example, the beam management circuitry 2544, together with the communication and processing circuitry 2542, the transceiver 2510, and antenna 2534, shown and described above in connection with FIG. 25, may provide a means to communicate with the network entity using the beam management scheme.

In some examples, the beam management scheme is a fully decoupled beam management scheme. The fully decoupled beam management scheme includes a first beam for the energy transmission and a second beam for the information transmission, where the first beam and the second beam are time division multiplexed. In this example, the UE capability may indicate the UE includes a time-splitting receiver architecture.

In some examples, the beam management scheme is a fully coupled beam management scheme that includes a same beam for both the energy transmission and the information transmission. In this example, the UE capability may indicate the UE includes a power-splitting receiver architecture supporting a superposition of the energy transmission and the information transmission for the fully coupled beam management scheme.

In some examples, the beam management scheme is a partially coupled beam management scheme. The partially coupled beam management scheme includes a first beam for the energy transmission and a second beam for the information transmission during a same time period. For example, the first beam can include a wide beam and the second beam can include a narrow beam.

In some examples, the UE may further transmit a beam failure report to the network entity based on the beam management scheme. For example, in the fully decoupled beam management scheme, the UE may transmit a beam failure report to the network entity in response to an energy conversion efficiency of the first beam being less than a threshold. In some examples, the energy conversion efficiency includes an average energy conversion efficiency over a time window or a maximum energy conversion efficiency during the time window. In other examples, the energy conversion efficiency includes a plurality of energy conversion efficiency values. In this example, the UE may initiate an energy beam failure indication timer and transmit the beam failure report to the network entity in response to a number of the plurality of energy conversion efficiency values that are less than the threshold at the expiration of the energy beam failure indication timer being greater than a maximum number. As another example, the UE may transmit a beam failure report to the network entity in response to a first energy conversion efficiency of a new beam being greater than a second energy conversion efficiency of the first beam. As another example, the UE may transmit a beam failure report to the network entity in response to a first average energy conversion efficiency of a new beam over a time window being greater than a second average energy conversion efficiency of the first beam over the time window.

In the fully coupled or partially coupled beam management scheme, the UE may transmit a beam failure report to the network entity in response to either a reference signal received power (RSRP) associated with the information transmission being less than a first threshold or an energy conversion efficiency of the energy transmission being less than a second threshold. As another example, the UE may transmit a beam failure report to the network entity in response to both a reference signal received power (RSRP) associated with the information transmission being less than a first threshold and an energy conversion efficiency of the energy transmission being less than a second threshold or both an additional RSRP associated with a new information beam being greater than the RSRP associated with the information transmission and an additional energy conversion efficiency associated with a new energy beam being greater than the energy conversion efficiency of the energy transmission.

As another example, in the fully coupled or partially coupled beam management scheme, the UE may transmit a beam failure report to the network entity in response to a first difference between a first energy conversion efficiency of a first new beam and a second energy conversion efficiency of a first current beam corresponding to the same beam or the wide beam is greater than a first threshold and a second difference between a first reference signal received power (RSRP) of a second current beam corresponding to the same beam or the narrow beam and a second RSRP of a second new beam being less than a second threshold, the first RSRP being less than the second RSRP. As yet another example, the UE may transmit a beam failure report to the network entity in response to a third difference between the second energy conversion efficiency of the first current beam and the first energy conversion efficiency of the first new beam being less than a third threshold and a fourth difference between the second RSRP of the second new beam and the first RSRP of the second current beam being greater than a second threshold, the first energy conversion efficiency being less than the second energy conversion efficiency.

In one configuration, the UE 2500 includes means for transmitting a UE capability to a network entity, the UE capability indicating a receiver architecture of the UE to support energy harvesting and information decoding, and means for communicating with the network entity using a beam management scheme based on the UE capability, the beam management scheme comprising one or more beams for providing an energy transmission and an information transmission to the UE, as described in the present disclosure. In one aspect, the aforementioned means may be the processor 2504 shown in FIG. 25 configured to perform the functions recited by the aforementioned means. In another aspect, the aforementioned means may be a circuit or any apparatus configured to perform the functions recited by the aforementioned means.

Of course, in the above examples, the circuitry included in the processor 2504 is merely provided as an example, and other means for carrying out the described functions may be included within various aspects of the present disclosure, including but not limited to the instructions stored in the computer-readable storage medium 2506, or any other suitable apparatus or means described in any one of the FIGS. 1, 2, and/or 5-8 utilizing, for example, the processes and/or algorithms described herein in relation to FIGS. 10, 12, 14, 17-24, and/or 26.

FIG. 27 is a conceptual diagram illustrating an example of a hardware implementation for an exemplary network entity 2700 employing a processing system 2714. For example, the network entity 2700 may correspond to any of the network entities (e.g., aggregated or disaggregated base stations) shown in any one or more of FIGS. 1, 2, 4, 5, 6, 8, and/or 10 and may include the circuitry shown in FIG. 9.

In accordance with various aspects of the disclosure, an element, or any portion of an element, or any combination of elements may be implemented with a processing system 2714 that includes one or more processors 2704. The processing system 2714 may be substantially the same as the processing system 1514 illustrated in FIG. 25, including a bus interface 2708, a bus 2702, memory 2705, a processor 2704, and a computer-readable medium 2706. Furthermore, the network entity 2700 may include an optional user interface 2712, a transceiver 2710, and an antenna 2534 (e.g., one or more antenna arrays). The processor 2704, as utilized in a network entity 2700, may be used to implement any one or more of the processes described herein.

In some examples, the memory 2705 may store one or more a UE capability (e.g., one or more UE capabilities) 2716, a beam management scheme (e.g., one or more beam management schemes) 2718, state-of-charge (SoC) feedback 2720, and/or latency requirements 2722 that may be utilized by the processor 2704 when executing software.

The processor 2704 may include communication and processing circuitry 2742 configured to communicate with one or more UEs via respective Uu links. In some examples, the communication and processing circuitry 2742 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 2742 may include one or more transmit/receive chains.

In some implementations where the communication involves receiving information, the communication and processing circuitry 2742 may obtain information from a component of the network entity 2700 (e.g., from the transceiver 2710 that receives the information via radio frequency signaling or some other type of signaling suitable for the applicable communication medium), process (e.g., decode) the information, and output the processed information. For example, the communication and processing circuitry 2742 may output the information to another component of the processor 2704, to the memory 2705, or to the bus interface 2708. In some examples, the communication and processing circuitry 2742 may receive one or more of signals, messages, other information, or any combination thereof. In some examples, the communication and processing circuitry 2742 may receive information via one or more channels. In some examples, the communication and processing circuitry 2742 may include functionality fora means for receiving. In some examples, the communication and processing circuitry 2742 may include functionality for a means for processing, including a means for demodulating, a means for decoding, etc.

In some implementations where the communication involves sending (e.g., transmitting) information, the communication and processing circuitry 2742 may obtain information (e.g., from another component of the processor 2704, the memory 2705, or the bus interface 2708), process (e.g., modulate, encode, etc.) the information, and output the processed information. For example, the communication and processing circuitry 2742 may output the information to the transceiver 2710 (e.g., that transmits the information via radio frequency signaling or some other type of signaling suitable for the applicable communication medium). In some examples, the communication and processing circuitry 2742 may send one or more of signals, messages, other information, or any combination thereof. In some examples, the communication and processing circuitry 2742 may send information via one or more channels. In some examples, the communication and processing circuitry 2742 may include functionality for a means for sending (e.g., a means for transmitting). In some examples, the communication and processing circuitry 2742 may include functionality for a means for generating, including a means for modulating, a means for encoding, etc.

The communication and processing circuitry 2742 may be configured to receive a UE capability 2716 of a UE and store the UE capability 2716 within, for example, memory 1705. The UE capability may indicate a receiver architecture of the UE to support energy harvesting and information decoding. The communication and processing circuitry 2742 may further be configured to communicate with the UE using a beam management scheme 2718 selected based on the UE capability 2716. The beam management scheme 2718 may include one or more beams for providing an energy transmission and an information transmission to the UE. In some examples, the communication and processing circuitry 2742 may further be configured to receive an indication of a preferred beam management scheme from the UE. In this example, the beam management scheme 2718 may correspond to the preferred beam management scheme The communication and processing circuitry 2742 may further be configured to execute communication and processing instructions (software) 2752 stored in the computer-readable medium 2706 to implement one or more of the functions described herein.

The processor 2704 may further include beam management scheme selection circuitry 2744, configured to select the beam management scheme 2718 based on the UE capability 2716. For example, the beam management scheme selection circuitry 2744 may select a fully decoupled beam management scheme. The fully decoupled beam management scheme uses a first beam for the energy transmission and a second beam for the information transmission, where the first beam and the second beam are time division multiplexed. The beam management scheme selection circuitry 2744 may select the fully decoupled beam management scheme in response to the UE capability 2716 indicating that the UE includes a time-splitting receiver architecture.

As another example, the beam management scheme selection circuitry 2744 may select a fully coupled beam management scheme. The fully coupled beam management scheme uses a same beam for both the energy transmission and the information transmission. The beam management scheme selection circuitry 2744 may select the fully coupled beam management scheme in response to the UE capability 2716 indicating that the UE includes a power-splitting receiver architecture supporting a superposition of the energy transmission and the information transmission.

As another example, the beam management scheme selection circuitry 2744 may select a partially coupled beam management scheme. The partially coupled beam management scheme uses a first beam for the energy transmission and a second beam for the information transmission during a same time period. The first beam may include a wide beam and the second beam may include a narrow beam. In some examples, the narrow beam may be in the same direction as the wide beam and within a beam width of the wide beam. The beam management scheme selection circuitry 2744 may select the partially coupled beam management scheme in response to the UE capability 2716 indicating that the UE includes a power-splitting receiver architecture supporting a superposition of the energy transmission and the information transmission. The beam management scheme selection circuitry 2744 may further be configured to execute beam management scheme selection instructions (software) 2754 stored in the computer-readable medium 2706 to implement one or more of the functions described herein.

The processor 2704 may further include beam selection circuitry 2746, configured to select one or more beams for communication of an energy transmission and an information transmission based on the selected beam management scheme 2718. In examples in which the fully decoupled beam management scheme is selected for communication with a UE, the beam selection circuitry 2746 may be configured to receive state-of-charge (SoC) feedback 2720 from the UE. The beam selection circuitry 2746 may then select a beam (e.g., a first beam) for providing the energy transmission to the UE based on the SoC feedback 2720. For example, if the SoC feedback from the UE indicates that the UE is in a low-energy state, the beam selection circuitry 2746 may determine to send the energy transmission to the UE using a selected beam (e.g., first beam). In some examples, the beam selection circuitry 2746 may select the first beam to provide the energy transmission to two or more UEs including the UE based on the respective SoC feedback 2720 from each of the two or more UEs. For example, the SoC feedback 2720 from each of the two or more UEs may indicate that each of the two or more UEs is in a low-energy state. In this example, the two or more UEs may be co-located UEs.

The beam selection circuitry 2746 may further identify a latency requirement 2722 of packets to be sent to the UE. The beam selection circuitry 2746 may then select a beam (e.g., a second beam) for providing the information transmission to the UE based on the latency requirement 2722. For example, if the latency requirement 2722 associated with packets for the UE indicates that the packets are low-latency packets, the beam selection circuitry 2746 may determine to send the information transmission including one or more of the packets to the UE using a selected beam (e.g., second beam). In some examples, the beam selection circuitry 2746 may further select an additional beam for providing an additional information transmission to an additional UE within a same time period as the information transmission based on an additional latency requirement 2722 associated with the additional UE. Here, the additional latency requirement 2722 may correspond to the latency requirement 2722 associated with the UE. For example, the latency requirements 2722 associated with respective packets to be sent to both the UE and the additional UE may indicate that the packets are low-latency packets. In this example, the UE and additional UE may be co-located or non-co-located.

In examples in which the fully coupled beam management scheme is selected for communication with a UE, the beam selection circuitry 2746 may be configured to receive SoC feedback 2720 from the UE and further to identify a latency requirement 2722 of packets to be transmitted to the UE. The beam selection circuitry 2746 may then select a same beam on which to provide both the energy transmission and the information transmission including one or more of the packets to the UE based on both the SoC feedback 2720 and the latency requirement 2722. In some examples, the beam selection circuitry 2746 may further provide a respective information transmission for each of two or more UEs including the UE on the same beam (e.g., based on similar SoC feedback and latency requirements associated with each of the two or more UEs). In this example, each of the two or more UEs may be co-located. In addition, each of the respective information transmissions may be separated in time or frequency.

In examples in which the partially coupled beam management scheme is selected for communication with a UE, the beam selection circuitry 2746 may select a first beam (e.g., wide beam) on which to provide the energy transmission to a group of UEs including the UE, a second beam (e.g., narrow beam) on which to provide the information transmission to the UE, and an additional narrow beam on which to provide an additional information transmission to an additional UE within the group of UEs or outside the group of UEs within the same time period. Here, the narrow beam and the additional narrow beam may be selected to avoid mutual interference between the information transmission and the additional information transmission. The beam selection circuitry 2746 may further be configured to execute beam selection instructions (software) 2756 stored in the computer-readable medium 2706 to implement one or more of the functions described herein.

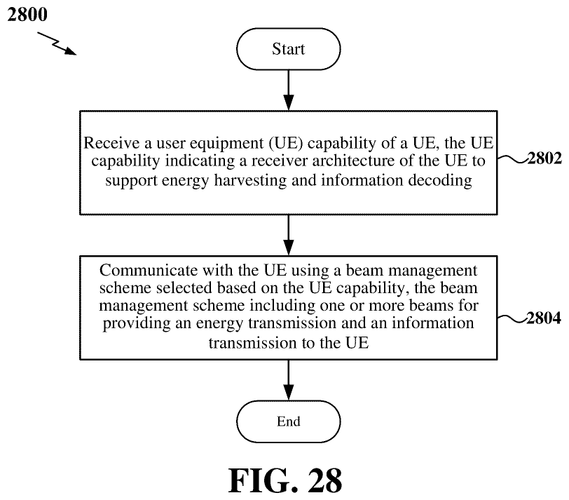

FIG. 28 is a flow chart of an exemplary method 2800 for beam management for wireless energy transfer according to some aspects. As described below, some or all illustrated features may be omitted in a particular implementation within the scope of the present disclosure, and some illustrated features may not be required for implementation of all examples. In some examples, the method may be performed by the network entity 2700, as described above and illustrated in FIG. 27, by a processor or processing system, or by any suitable means for carrying out the described functions.

At block 2802, the network entity may receive a user equipment (UE) capability of a UE. The UE capability may indicate a receiver architecture of the UE to support energy harvesting and information decoding. For example, the communication and processing circuitry 2742, together with the transceiver 2710, shown and described above in connection with FIG. 27, may provide a means to receive the UE capability.

At block 2804, the network entity may communicate with the UE using a beam management scheme selected based on the UE capability. The beam management scheme may include one or more beams for providing an energy transmission and an information transmission to the UE. In some examples, the network entity may further receive an indication of a preferred beam management scheme from the UE. In this example, the beam management scheme can correspond to the preferred beam management scheme. For example, the communication and processing circuitry 2742, together with the beam management scheme selection circuitry 2744, beam selection circuitry 2746, transceiver 2710, and antenna 2734, shown and described above in connection with FIG. 27, may provide a means to communicate with the UE using the beam management scheme.

In some examples, the beam management scheme includes a fully decoupled beam management scheme. The fully decoupled beam management scheme including a first beam for the energy transmission and a second beam for the information transmission, the first beam and the second beam being time division multiplexed. In this example, the UE capability may indicate that the UE includes a time-splitting receiver architecture. In some examples, the network entity may further receive state-of-charge feedback from the UE, provide the energy transmission using the first beam based on the state-of-charge, identify a latency requirement of packets to be transmitted to the UE, and provide the information transmission including one or more of the packets to the UE using the second beam based on the latency requirement. In some examples, the UE may provide the energy transmission using the first beam to two or more UEs including the UE based on a respective state-of-charge feedback from each of the two or more UEs. In some examples, the UE may provide an additional information transmission to an additional UE within a same time period as the information transmission using an additional beam based on an additional latency requirement associated with the additional UE corresponding to the latency requirement associated with the UE.

In some examples, the beam management scheme includes a fully coupled beam management scheme. The fully coupled beam management scheme includes a same beam for both the energy transmission and the information transmission. In this example, the UE capability may indicate that the UE includes a power-splitting receiver architecture supporting superposition of the energy transmission and the information transmission. In some examples, the network entity may further receive state-of-charge feedback from the UE, identify a latency requirement of packets to be transmitted to the UE, and provide the energy transmission and the information transmission including one or more of the packets to the UE using the same beam based on the state-of-charge feedback and the latency requirement. In some examples, the information transmission includes a respective information transmission for each of two or more UEs including the UE, in which each of the respective information transmissions being separated in time or frequency. In addition, the energy transmission is provided to each of the two or more UEs.

In some examples, the beam management scheme includes a partially coupled beam management scheme. The partially coupled beam management scheme including a first beam for the energy transmission and a second beam for the information transmission during a same time period. The first beam includes a wide beam and the second beam includes a narrow beam. In some examples, the network entity may further provide the energy transmission to a group of UEs including the UE using the first beam, and provide an additional information transmission to an additional UE within the group of UEs within the same time period using an additional narrow beam selected to avoid mutual interference between the information transmission and the additional information transmission. In some examples, the network entity may further provide the energy transmission to a group of UEs including the UE using the first beam, and provide an additional information transmission to an additional UE outside the group of UEs within the same time period using an additional narrow beam selected to avoid mutual interference between the information transmission and the additional information transmission.

In one configuration, the network entity 2700 includes means for receiving a user equipment (UE) capability of a UE, the UE capability indicating a receiver architecture of the UE to support energy harvesting and information decoding, and means for communicating with the UE using a beam management scheme selected based on the UE capability, the beam management scheme comprising one or more beams for providing an energy transmission and an information transmission to the UE, as described in the present disclosure. In one aspect, the aforementioned means may be the processor 2704 shown in FIG. 27 configured to perform the functions recited by the aforementioned means. In another aspect, the aforementioned means may be a circuit or any apparatus configured to perform the functions recited by the aforementioned means.

Of course, in the above examples, the circuitry included in the processor 2704 is merely provided as an example, and other means for carrying out the described functions may be included within various aspects of the present disclosure, including but not limited to the instructions stored in the computer-readable storage medium 2706, or any other suitable apparatus or means described in any one of the FIGS. 1, 2, 4-6, 9, and/or 10 utilizing, for example, the processes and/or algorithms described herein in relation to FIGS. 10-16 and/or 28.

The processes shown in FIGS. 10-24, 26, and 28 may include additional aspects, such as any single aspect or any combination of aspects described below and/or in connection with one or more other processes described elsewhere herein.
Aspect 1: A method operable at a network entity, the method comprising: receiving a user equipment (UE) capability of a UE, the UE capability indicating a receiver architecture of the UE to support energy harvesting and information decoding; and communicating with the UE using a beam management scheme selected based on the UE capability, the beam management scheme comprising one or more beams for providing an energy transmission and an information transmission to the UE.
Aspect 2: The method of aspect 1, wherein the beam management scheme comprises a fully decoupled beam management scheme, the fully decoupled beam management scheme comprising a first beam for the energy transmission and a second beam for the information transmission, the first beam and the second beam being time division multiplexed.
Aspect 3: The method of aspect 2, wherein the UE capability indicates the UE comprises a time-splitting receiver architecture.
Aspect 4: The method of aspect 2 or 3, wherein the communicating with the UE using the fully decoupled beam management scheme further comprises: receiving state-of-charge feedback from the UE; providing the energy transmission using the first beam based on the state-of-charge; identifying a latency requirement of packets to be transmitted to the UE; and providing the information transmission comprising one or more of the packets to the UE using the second beam based on the latency requirement.
Aspect 5: The method of aspect 4, wherein the providing the energy transmission using the first beam based on the state-of-charge feedback further comprises: providing the energy transmission using the first beam to two or more UEs including the UE based on a respective state-of-charge feedback from each of the two or more UEs.
Aspect 6: The method of aspect 4 or 5, further comprising: providing an additional information transmission to an additional UE within a same time period as the information transmission using an additional beam based on an additional latency requirement associated with the additional UE corresponding to the latency requirement associated with the UE.
Aspect 7: The method of aspect 1, wherein the beam management scheme comprises a fully coupled beam management scheme, the fully coupled beam management scheme comprising a same beam for both the energy transmission and the information transmission.
Aspect 8: The method of aspect 7, wherein the UE capability indicates the UE comprises a power-splitting receiver architecture supporting a superposition of the energy transmission and the information transmission.
Aspect 9: The method of aspect 7 or 8, wherein the communicating with the UE using the fully decoupled beam management scheme further comprises: receiving state-of-charge feedback from the UE; identifying a latency requirement of packets to be transmitted to the UE; and providing the energy transmission and the information transmission comprising one or more of the packets to the UE using the same beam based on the state-of-charge feedback and the latency requirement.
Aspect 10: The method of aspect 9, wherein: the information transmission comprises a respective information transmission for each of two or more UEs including the UE, each of the respective information transmissions being separated in time or frequency; and the energy transmission is provided to each of the two or more UEs.
Aspect 11: The method of aspect 1, wherein the beam management scheme comprises a partially coupled beam management scheme, the partially coupled beam management scheme comprising a first beam for the energy transmission and a second beam for the information transmission during a same time period, the first beam comprising a wide beam and the second beam comprising a narrow beam.
Aspect 12: The method of aspect 11, wherein the communicating with the UE using the partially coupled beam management scheme comprises: providing the energy transmission to a group of UEs including the UE using the first beam; and providing an additional information transmission to an additional UE within the group of UEs within the same time period using an additional narrow beam selected to avoid mutual interference between the information transmission and the additional information transmission.
Aspect 13: The method of aspect 11, wherein communicating with the UE using the partially coupled beam management scheme comprises: providing the energy transmission to a group of UEs including the UE using the first beam; and providing an additional information transmission to an additional UE outside the group of UEs within the same time period using an additional narrow beam selected to avoid mutual interference between the information transmission and the additional information transmission.
Aspect 14: The method of any of aspects 1 through 13, further comprising: receiving an indication of a preferred beam management scheme from the UE, the beam management scheme corresponding to the preferred beam management scheme.
Aspect 15: A method operable at a user equipment (UE), the method comprising: transmitting a UE capability to a network entity, the UE capability indicating a receiver architecture of the UE to support energy harvesting and information decoding; and communicating with the network entity using a beam management scheme based on the UE capability, the beam management scheme comprising one or more beams for providing an energy transmission and an information transmission to the UE.
Aspect 16: The method of aspect 15, wherein the beam management scheme comprises a fully decoupled beam management scheme, the fully decoupled beam management scheme comprising a first beam for the energy transmission and a second beam for the information transmission, the first beam and the second beam being time division multiplexed.
Aspect 17: The method of aspect 16, wherein the UE capability indicates the UE comprises a time-splitting receiver architecture.
Aspect 18: The method of aspect 16 or 17, further comprising: transmitting a beam failure report to the network entity in response to an energy conversion efficiency of the first beam being less than a threshold.
Aspect 19: The method of aspect 18, wherein the energy conversion efficiency comprises an average energy conversion efficiency over a time window or a maximum energy conversion efficiency during the time window.
Aspect 20: The method of aspect 18, wherein the energy conversion efficiency comprises a plurality of energy conversion efficiency values, and wherein the transmitting the beam failure report to the network entity in response to the energy conversion efficiency of the first beam being less than the threshold further comprises: initiating an energy beam failure indication timer; and transmitting the beam failure report to the network entity in response to a number of the plurality of energy conversion efficiency values that are less than the threshold at the expiration of the energy beam failure indication timer being greater than a maximum number.
Aspect 21: The method of aspect 16, further comprising: transmitting a beam failure report to the network entity in response to a first energy conversion efficiency of a new beam being greater than a second energy conversion efficiency of the first beam.
Aspect 22: The method of aspect 16, further comprising: transmitting a beam failure report to the network entity in response to a first average energy conversion efficiency of a new beam over a time window being greater than a second average energy conversion efficiency of the first beam over the time window.
Aspect 23: The method of aspect 15, wherein the beam management scheme comprises a fully coupled beam management scheme or a partially coupled beam management scheme, the fully coupled beam management scheme comprising a same beam for both the energy transmission and the information transmission, the partially coupled beam management scheme comprising a first beam for the energy transmission and a second beam for the information transmission during a same time period, the first beam comprising a wide beam and the second beam comprising a narrow beam.
Aspect 24: The method of aspect 23, wherein the UE capability indicates the UE comprises a power-splitting receiver architecture supporting a superposition of the energy transmission and the information transmission for the fully coupled beam management scheme.
Aspect 25: The method of claim 23, further comprising: transmitting a beam failure report to the network entity in response to either a reference signal received power (RSRP) associated with the information transmission being less than a first threshold or an energy conversion efficiency of the energy transmission being less than a second threshold.
Aspect 26: The method of aspect 23, further comprising: transmitting a beam failure report to the network entity in response to both a reference signal received power (RSRP) associated with the information transmission being less than a first threshold and an energy conversion efficiency of the energy transmission being less than a second threshold or both an additional RSRP associated with a new information beam being greater than the RSRP associated with the information transmission and an additional energy conversion efficiency associated with a new energy beam being greater than the energy conversion efficiency of the energy transmission.
Aspect 27: The method of aspect 23, further comprising: transmitting a beam failure report to the network entity in response to a first difference between a first energy conversion efficiency of a first new beam and a second energy conversion efficiency of a first current beam corresponding to the same beam or the wide beam is greater than a first threshold and a second difference between a first reference signal received power (RSRP) of a second current beam corresponding to the same beam or the narrow beam and a second RSRP of a second new beam being less than a second threshold, the first RSRP being less than the second RSRP.
Aspect 28: The method of aspect 23, further comprising: transmitting a beam failure report to the network entity in response to a third difference between the second energy conversion efficiency of the first current beam and the first energy conversion efficiency of the first new beam being less than a third threshold and a fourth difference between the second RSRP of the second new beam and the first RSRP of the second current beam being greater than a second threshold, the first energy conversion efficiency being less than the second energy conversion efficiency.
Aspect 29: The method of any of aspects 15 through 28, further comprising: transmitting an indication of a preferred beam management scheme to the network entity, the beam management scheme corresponding to the preferred beam management scheme.
Aspect 30: A network entity configured for wireless communication comprising a memory and processor coupled to the memory, the processor being configured to perform a method of any one of aspects 1 through 14.
Aspect 31: A network entity comprising at least one means for performing a method of any one of aspects 1 through 14.
Aspect 32: A non-transitory computer-readable medium having stored therein instructions executable by one or more processors of a network entity to perform a method of any one of aspects 1 through 14.
Aspect 33: A user equipment (UE) configured for wireless communication comprising a transceiver, a memory, and processor coupled to the transceiver and the memory, the processor being configured to perform a method of any one of aspects 15 through 29.
Aspect 34: A UE comprising at least one means for performing a method of any one of aspects 15 through 29.
Aspect 35: A non-transitory computer-readable medium having stored therein instructions executable by one or more processors of a network entity to perform a method of any one of aspects 15 through 29.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3G PP2), such as CDMA2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-28 may be rearranged and/or combined into a single component, step, feature or function or embodied in several components, steps, or functions. Additional elements, components, steps, and/or functions may also be added without departing from novel features disclosed herein. The apparatus, devices, and/or components illustrated in FIGS. 1, 2, 4-10, 25, and/or 27 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b, and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A network entity configured for wireless communication, comprising:
a memory; and
a processor coupled to the memory, the processor being configured to:
receive a user equipment (UE) capability of a UE, the UE capability indicating a receiver architecture of the UE to support energy harvesting and information decoding; and
communicate with the UE using a beam management scheme selected based on the UE capability, the beam management scheme comprising one or more beams for providing an energy transmission and an information transmission to the UE.

2. The network entity of claim 1, wherein the beam management scheme comprises a fully decoupled beam management scheme, the fully decoupled beam management scheme comprising a first beam for the energy transmission and a second beam for the information transmission, the first beam and the second beam being time division multiplexed.

3. (canceled)

4. The network entity of claim 2, wherein the processor is further configured to:
receive state-of-charge feedback from the UE;
provide the energy transmission using the first beam based on the state-of-charge feedback;
identify a latency requirement of packets to be transmitted to the UE; and
provide the information transmission comprising one or more of the packets to the UE using the second beam based on the latency requirement.

5. The network entity of claim 4, wherein the processor is further configured to:
provide the energy transmission using the first beam to two or more UEs including the UE based on a respective state-of-charge feedback from each of the two or more UEs.

6. The network entity of claim 4, wherein the processor is further configured to:
provide an additional information transmission to an additional UE within a same time period as the information transmission using an additional beam based on an additional latency requirement associated with the additional UE corresponding to the latency requirement associated with the UE.

7. The network entity of claim 1, wherein the beam management scheme comprises a fully coupled beam management scheme, the fully coupled beam management scheme comprising a same beam for both the energy transmission and the information transmission.

8. The network entity of claim 7, wherein the UE capability indicates the UE comprises a power-splitting receiver architecture supporting a superposition of the energy transmission and the information transmission.

9. The network entity of claim 7, wherein the processor is further configured to:
receive state-of-charge feedback from the UE;
identify a latency requirement of packets to be transmitted to the UE; and
provide the energy transmission and the information transmission comprising one or more of the packets to the UE using the same beam based on the state-of-charge feedback and the latency requirement.

10. The network entity of claim 9, wherein:
the information transmission comprises a respective information transmission for each of two or more UEs including the UE, each of the respective information transmissions being separated in time or frequency; and
the energy transmission is provided to each of the two or more UEs.

11. The network entity of claim 1, wherein the beam management scheme comprises a partially coupled beam management scheme, the partially coupled beam management scheme comprising a first beam for the energy transmission and a second beam for the information transmission during a same time period, the first beam comprising a wide beam and the second beam comprising a narrow beam.

12. (canceled)

13. (canceled)

14. (canceled)

15. A user equipment (UE) configured for wireless communication, comprising:
a transceiver;
a memory; and
a processor coupled to the transceiver and the memory, the processor being configured to:
transmit a UE capability to a network entity via the transceiver, the UE capability indicating a receiver architecture of the UE to support energy harvesting and information decoding; and
communicate with the network entity using a beam management scheme based on the UE capability, the beam management scheme comprising one or more beams for providing an energy transmission and an information transmission to the UE.

16. The UE of claim 15, wherein the beam management scheme comprises a fully decoupled beam management scheme, the fully decoupled beam management scheme comprising a first beam for the energy transmission and a second beam for the information transmission, the first beam and the second beam being time division multiplexed.

17. (canceled)

18. The UE of claim 16, wherein the processor is further configured to:
transmit a beam failure report to the network entity in response to an energy conversion efficiency of the first beam being less than a threshold.

19. (canceled)

20. The UE of claim 18, wherein the energy conversion efficiency comprises a plurality of energy conversion efficiency values, and wherein the processor is further configured to:
initiate an energy beam failure indication timer; and
transmit the beam failure report to the network entity in response to a number of the plurality of energy conversion efficiency values that are less than the threshold at an expiration of the energy beam failure indication timer being greater than a maximum number.

21. The UE of claim 16, wherein the processor is further configured to:
transmit a beam failure report to the network entity in response to a first energy conversion efficiency of a new beam being greater than a second energy conversion efficiency of the first beam.

22. (canceled)

23. The UE of claim 15, wherein the beam management scheme comprises a fully coupled beam management scheme or a partially coupled beam management scheme, the fully coupled beam management scheme comprising a same beam for both the energy transmission and the information transmission, the partially coupled beam management scheme comprising a first beam for the energy transmission and a second beam for the information transmission during a same time period, the first beam comprising a wide beam and the second beam comprising a narrow beam.

24. (canceled)

25. The UE of claim 23, wherein the processor is further configured to:
transmit a beam failure report to the network entity in response to either a reference signal received power (RSRP) associated with the information transmission being less than a first threshold or an energy conversion efficiency of the energy transmission being less than a second threshold.

26. The UE of claim 23, wherein the processor is further configured to:
transmit a beam failure report to the network entity in response to both a reference signal received power (RSRP) associated with the information transmission being less than a first threshold and an energy conversion efficiency of the energy transmission being less than a second threshold or both an additional RSRP associated with a new information beam being greater than the RSRP associated with the information transmission and an additional energy conversion efficiency associated with a new energy beam being greater than the energy conversion efficiency of the energy transmission.

27. The UE of claim 23, wherein the processor is further configured to:
transmit a beam failure report to the network entity in response to a first difference between a first energy conversion efficiency of a first new beam and a second energy conversion efficiency of a first current beam corresponding to the same beam or the wide beam is greater than a first threshold and a second difference between a first reference signal received power (RSRP) of a second current beam corresponding to the same beam or the narrow beam and a second RSRP of a second new beam being less than a second threshold, the first RSRP being less than the second RSRP; or
transmit the beam failure report to the network entity in response to a third difference between the second energy conversion efficiency of the first current beam and the first energy conversion efficiency of the first new beam being less than a third threshold and a fourth difference between the second RSRP of the second new beam and the first RSRP of the second current beam being greater than a second threshold, the first energy conversion efficiency being less than the second energy conversion efficiency.

28. (canceled)

29. (canceled)

30. A method operable at a user equipment (UE), the method comprising:
transmitting a UE capability to a network entity, the UE capability indicating a receiver architecture of the UE to support energy harvesting and information decoding; and
communicating with the network entity using a beam management scheme based on the UE capability, the beam management scheme comprising one or more beams for providing an energy transmission and an information transmission to the UE.
